(19) United States
(12) Patent Application Publication
(10) Pub. No.: US 2025/0194650 A1
(43) Pub. Date: Jun. 19, 2025

(54) FLAVOR MATERIALS AND COMPOSITIONS CONTAINING SAME

(71) Applicant: THE MEDITERRANEAN FOOD LAB LTD, Tel Aviv (IL)

(72) Inventor: Ben Z. GOLDBERG, Harei Yehuda (IL)

(21) Appl. No.: 18/847,352

(22) PCT Filed: Mar. 19, 2023
(86) PCT No.: PCT/IL2023/050286

§ 371 Date: Sep. 16, 2024

(30) Foreign Application Priority Data
Mar. 20, 2022 (IL) 291504

(51) Int. Cl. A23L 27/26; A23L 27/00; A23L 27/20; A23L 27/21; A23L 27/24

(52) U.S. Cl. CPC A23L 27/26; A23L 27/2024; A23L 27/2052; A23L 27/21; A23L 27/24; A23L 27/88

(57) ABSTRACT

Provided are meatless flavor materials containing at least one volatile substance at an odor activity value (OAV) of at least 10, the volatile substance comprising 2,3-Octanedione; and a non-volatile taste distribution of: about 50-85% non-volatile taste substances having a sweet or sour taste, about 3-25% non-volatile taste substances having a sour taste; about 4-25% non-volatile taste substances having a bitter taste; and about 2-10% of non-volatile taste substances having an umami taste out of a total amount of non-volatile taste substances. Further provided are uses thereof for enhancing flavor and food products comprising the same.

### TECHNOLOGICAL FIELD

The present invention relates to flavor and sensorial materials and consumable compositions comprising the same, in particular, meatless, plant-based, animal protein-free flavor materials and compositions imparting a meaty and/or animal protein-like flavor to food stuff to which they are added.

### BACKGROUND OF THE INVENTION

With the advent of industrialized animal agriculture, the consumption of animal meat has become extensive. However, animal agriculture requires a significant amount of land use fresh water and finite resources that are becoming increasingly difficult to access. Moreover, sustainability and ethical concerns over animal meat consumption have caused the food industry to realize the need for plant-based alternatives. Yet, many of the current plant-based alternatives have not been able to penetrate the market in a meaningful manner due to lack of consumer acceptance which stems from differences in taste, texture and visual appeal.

To improve the sustainability of the food ecosystem it is imperative that plant-based products are developed that appeal to consumers who currently prefer meat.

### SUMMARY OF THE INVENTION

The present invention in embodiments thereof provides consumable flavor-rich flavor and sensorial materials, as well as compositions and food products containing the same. The flavor materials are animal protein-free, yet, advantageously provide to food stuff to which they are added, the complex taste and aroma, typically associated with animal protein (e.g. meat, milk, butter, cream, cheese, fish, etc.), products derived from animal protein, or foods prepared with animal protein or such products.

Distinctively, the herein disclosed consumable flavor materials and compositions serve to create and enhance the experience of “deliciousness” in general and in animal protein analogues in particular, and to elevate the taste experience of consuming such products and make it as close as possible to the total experience of consuming animal protein or materials prepared with animal protein, as opposed to currently available flavor solutions which focus on imitating particular attributes of meat/animal protein. In short, the herein disclosed consumable flavor and sensorial materials and compositions containing same are characterized by helping plant-based food taste delicious in the way that foods prepared with animal protein are delicious; putting the pleasure of consuming food at the center.

Advantageously, it was discovered by the inventors of the herein disclosed flavor materials and compositions that in it is possible to obtain a plant-based food stuff that provides a pleasure-inducing taste-experience characteristic to animal protein or foods prepared with animal protein, by adding to such food stuff flavor materials and/or compositions which abide to certain criteria. Such criteria include for example the presence of at least one volatile substance at an odor activity value (OAV) of at least 10 when the flavor material(s) are concentrated so that their Brix value is approximately 60° Bx to 80° Bx and/or their water content (moisture level) is approximately 40% to 60%. Such criteria also include for example a non-volatile taste distribution characterized by about 50-85% (for example, about 60-80%) non-volatile taste substances having a sweet, and/or about 3-25% (for example, about 3-7%) non-volatile taste substances having a sour taste, and/or about 4-25% (for example, about 4-7%) non-volatile taste substances having a bitter taste and/or about 2-10% (for example, about 8-10%) of non-volatile taste substances having an umami taste, (all out of the total amount of non-volatile taste substances).

According to some embodiments, there is provided a consumable flavor rich flavor material comprising: at least one volatile substance at an odor activity value (OAV) of at least 10, the volatile substances may be selected from: 2,3-Octanedione, 3-methyl-Butanal, 2-methyl-Butanal, 2,6-dimethyl-Pyrazine, a-ethylidene-Benzeneacetaldehyde, dimethyl Trisulfide, 1H-indole, 2-Propenal, Hexanal and Hexadecanoic acid, ethyl ester; and a non-volatile taste distribution of: about 50-85% non-volatile taste substances having a sweet or sour taste, about 3-25% non-volatile taste substances having a sour taste; about 4-25% non-volatile taste substances having a bitter taste; and about 2-10% of non-volatile taste substances having an umami taste out of a total amount of non-volatile taste substances; wherein the flavor material is meatless.

According to some embodiments, the at least one volatile substance may further include one or more of: 1H-indole, Ethyl linoleate, Acetaldehyde phenyl-dimethyl acetal, and 2,3-Butanediol. Each possibility is a separate embodiment.

According to some embodiments, the taste substances having a sweet taste comprises alanine, proline, fructose, rhamnose, asparagine, serine, mannitol, sucrose, glutamine, threonine, myo-inositol, glycine, glucose and raffinose. Each possibility is a separate embodiment. According to some embodiments, the consumable flavor rich flavor material comprises isomaltose at an IRR of at least 40. According to some embodiments, the taste substances having a sweet taste comprises glucose.

According to some embodiments, the taste substances having a sour taste comprises lactic acid, citric acid, maleic acid, succinic acid and tartaric acid. Each possibility is a separate embodiment. According to some embodiments, the taste substances having a sour taste comprises lactic acid. According to some embodiments, the consumable flavor rich flavor material comprises lactic acid at an IRR of at least 40.

According to some embodiments, the taste substances having a bitter taste comprises an amino acid including, for example, arginine, cystine, histidine, isoleucine, leucine, lysine, methionine, phenylalanine, tryptophan, tyrosine and/or valine. Each possibility is a separate embodiment. According to some embodiments, the taste substances having a bitter taste comprises arginine.

According to some embodiments, the taste substances having an umami taste include an amino acid, such as, for example, glutamate, aspartate, and/or betaine. Each possibility is a separate embodiment. In some embodiments, the umami taste substance may be selected from uridine 5′-monophosphate (5′-Ump), aspartic acid, glutamic acid, adenosine 5′-monophosphate (Amp), guanosine 5′-monophosphate (Gmp), or combinations thereof. Each possibility is a separate embodiment. According to some embodiments, the umami taste substance comprises glutamate.

According to some embodiments, the consumable flavor rich flavor material has a meaty flavor.

According to some embodiments, the consumable flavor rich flavor material is obtained by solid state or submerged (liquid state) fermentation of one or more legumes, grains, oilseeds, vegetables, nuts, agro-industrial waste streams or any combinations thereof.

In some embodiments, the legume may be selected from, but not limited to: chickpeas, soybeans, black beans, white beans, green beans, kidney beans, red beans, broad beans, lima beans, blacked-eyed peas, navy beans, adzuki beans, mung beans, lupin, green lentils, black lentils, red/yellow lentils, fava beans, broad beans, Cranberry (Borlotti) Beans, green peas, yellow peas, peanuts, bambara nut, and the like.

According to some embodiments, there is provided a consumable composition comprising the herein disclosed flavor rich flavor material.

According to some embodiments, the consumable composition further comprises a flavor base. According to some embodiments, the flavor base is plant based (vegetarian/vegan).

According to some embodiments, there is provided a method for providing meaty flavor to a meatless food product, the method comprising the addition of the herein disclosed consumable flavor rich flavor material or the herein disclosed composition to the meatless food product.

According to some embodiments, the food product is a ready-to-cook or ready-to-eat food product. According to some embodiments, the meatless food product is a ready-to-cook or ready-to-eat meat-less food product.

According to some embodiments, there is provided a food product comprising the herein disclosed consumable, flavor rich flavor material or the herein disclosed composition.

According to some embodiments, the food product is a plant-based food product. According to some embodiments, the food product is a sauce and/or a condiment. According to some embodiments, the food product is a prepared food such as a casserole, stew, legume or grain-based dish, soup, or the like. According to some embodiments, the food product is a stock, or bullion, fish-sauce or “dashi” analogue. According to some embodiments, the stock, bullion, and/or fish-sauce analogue is concentrated. According to some embodiments, the food product is a taste modulator or taste intensifier/enhancer.

According to some embodiments, the flavor material is capable of at least partially masking beany off-flavors.

According to some embodiments, the flavor material is capable of at least partially masking bitterness.

According to some embodiments, the flavor material is capable of at least partially masking off-flavors typical of alternative sweeteners, such as stevia.

According to some embodiments, the flavor material can at least partially increase the perception of fattiness including the mouthfeel typical of increased fattiness.

According to some embodiments, the flavor material may at least partially function as a “sweetness modulator”, for example by modulating and improving the mouthfeel of a product with a reduced sugar content so that the mouthfeel is more reminiscent of that of a product prepared with a customary quantity of sugar.

According to some embodiments, the flavor material may improve creamy and/or milk-fatty mouthfeel.

According to some embodiments, the flavor material can increase the complexity of taste in reduced salt food products, including, without limitation, in low pH food products.

According to some embodiments, the flavor material is capable of at least partially “masking” and/or “blocking” astringency.

According to some embodiments, the flavor material is at least partially capable of “masking” and/or “blocking” sour taste.

According to some embodiments, the flavor material is capable of any of the above attributes in a food product which is plant-based, or a food product which is not essentially plant based.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 presents a schematic block diagram of flavor materials production process, according to some embodiments.

FIG. 2 shows a hierarchical clustering dendrogram of volatile and non-volatile compounds combined in the herein disclosed flavor material, meat products as well as a variety of non-meat flavorings (here shown: Industrial “meaty” flavoring, Imitation meat bouillon). Analysis was done in JMP software using Maximum Likelihood method. Distance between clusters was calculated using Ward method. Similar products are clustered into one trunk.

FIG. 3 presents known volatile materials represented in meat jus, an example of herein disclosed flavor material and non-meat flavorings (here shown: Industrial “meaty” flavoring, Imitation meat bullion). (Visual analysis created using Venny 2.1).

FIGS. 4A-4C present the concentration of different volatile component represented in meat jus, flavor material and non-meat flavorings (here shown: Industrial “meaty” flavoring, Imitation meat bouillon).

FIG. 5 presents a stacked column chart showing the distribution of umami substances in the herein disclosed flavor material as well as in representative meat products and known non-meat flavorings (here shown: Industrial “meaty” flavoring, Imitation meat bouillon).

FIG. 6 presents a stacked column chart showing the distribution of sour substances in the herein disclosed flavor materials as well as in representative meat products and known meat-free flavorings (here shown: Industrial “meaty” flavoring, Imitation meat bouillon).

FIG. 7 presents a stacked column chart showing the distribution of sweet substances in the herein disclosed flavor materials as well as in representative meat products and known meat-free flavorings (here shown: Industrial “meaty” flavoring, Imitation meat bouillon).

FIG. 8 presents a stacked column chart showing the distribution of bitter substances in the herein disclosed flavor materials as well as in representative meat products and known non-meat flavorings (here shown: Industrial “meaty” flavoring, Imitation meat bouillon).

FIG. 9 presents a stacked column chart showing the distribution of koku (also known as “kokumi”) substances in the herein disclosed flavor materials as in representative meat products and known meat-free flavorings (here shown: Industrial “meaty” flavoring, Imitation meat bouillon).

FIG. 10A presents a column chart showing a paired comparison test (2-AFC) for fat perception of the reference sample “plant-based burger” with and without the herein disclosed flavor materials.

FIG. 10B presents a graphical display (spider graphs) of sensory attributes based on Quantitative Descriptive Analysis (QDA) test results of “plant burger” and of “plant burger” including the herein disclosed flavor materials for the taste sensations: salty, sweet, bitter, sour, and astringent.

FIG. 11A presents a column chart showing a paired comparison test (2-AFC) for bitter perception of the reference sample of a commercial tonic water with and without the herein disclosed flavor materials.

FIG. 11B presents a graphical display (spider graph) of sensory attributes based on Quantitative Descriptive Analysis (QDA) test results of a commercial tonic water with and without the herein disclosed flavor materials for the taste sensations: salty, sweet, bitter, sour, and astringent.

FIG. 12A presents a column chart showing the paired comparison test (2-AFC) for acidity perception of a reference sample of lemon juice with and without the herein disclosed flavor materials.

FIG. 12B presents a graphical display (spider graphs) of sensory attributes based on Quantitative Descriptive Analysis (QDA) test results of lemon juice with and without the herein disclosed flavor materials for the taste sensations: salty, sweet, bitter, sour, and astringent.

FIG. 13A presents a column chart showing the paired comparison test (2-AFC) for beany off-flavor perception of the reference sample 6% pea flour in water with and without the herein disclosed flavor materials.

FIG. 13B presents a graphical display (spider graphs) of sensory attributes based on Quantitative Descriptive Analysis (QDA) test results of 6% pea flour in water with and without the herein disclosed flavor materials for the taste sensations: salty, sweet, bitter, sour, and astringent.

FIG. 14A presents a column chart showing the paired comparison test (2-AFC) for astringency perception of a reference sample of cranberry juice with and without the herein disclosed flavor materials.

FIG. 14B presents a paired comparison test (2-AFC) for stevia off-flavor perception of a reference sample containing 3% stevia in water with and without the herein disclosed flavor materials.

FIG. 14C presents a paired comparison test (2-AFC) for mouthfeel perception of a reference sample of milk 1% fat with and without the herein disclosed flavor materials.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

For convenience, certain terms used in the specification, examples, and appended claims are collected here. Unless otherwise defined, all technical and scientific terms used herein have the same meaning as commonly understood by one of ordinary skill in the art to which this invention pertains.

There is provided herein, according to some aspects of the disclosure, a consumable flavor-rich, plant-based flavor material, which includes 2,3 octanedione at an odor activity value (OAV) of at least 10 (as defined herein) and having a non-volatile taste distribution of: about 50%-85% (for example, about 75-85%) taste substances having a sweet or sour taste, about 3-25% (for example, about 3.5-10%) non-volatile taste substances having a sour taste, about 4-25% (for example, about 4.5-8%) non-volatile taste substances having a bitter taste; and about 2-12% (for example, about 8-10%) of non-volatile taste substances having an umami taste out of a total amount of non-volatile taste substances. In some embodiments, the flavor material may further include non-volatile koku substances.

As used herein, the terms “flavor material”, “flavor materials”, “FM”, “FMs”, “MFL flavor material”, “MFL” and “flavor product(s)” may be used interchangeably. The terms refer to a product (such as a flavor concentrate, etc.) prepared by a process of fermentation of legumes and/or grains and/or materials prepared from such, and/or waste streams from the processing of such. According to some embodiments, the flavor material may be a solution, a viscous liquid, a paste, a powder, or a dry granulated substance among others, containing essential constituents of a complex material, such as plants. According to some embodiments, the flavor material is devoid of any synthetic and/or added natural and/or artificial flavor or aroma substances. According to some embodiments, the flavor material is devoid of any materials commonly considered by regulatory authorities to be additives, flavors, aromas, “E-numbers”, or other such ingredients. According to some embodiments, the flavor material is comprised only of commonly recognizable food ingredients that an average consumer might have in their kitchen at any given time (“kitchen cupboard” ingredients, also commonly known as “foodstuff” ingredients). According to some embodiments a flavor material may include a combination or mixture of distinct flavor or sensorial materials.

As used herein, the term “meatless”, “meat free” and “animal protein free” may be used interchangeably and refer to products which contain no meat, meat substances or other animal protein or animal protein substances, and which are produced in an animal protein-free process. According to some embodiments, the flavor material is vegetarian. According to some embodiments, the flavor material is vegan. According to some embodiments, the flavor material is non-diary.

As used herein, the term “taste sensation” refers to the sensation that results when taste receptors in the oral cavity (for example, mouth, on the tongue and/or throat), and/or elsewhere throughout the digestive system to convey information about the chemical composition of a soluble stimulus. As used herein, the term “aromatic sensation” refers to a sense of smells (or odor) or olfaction. It occurs when an odor binds to a receptor within the nasal cavity or elsewhere, transmitting a signal through the olfactory system.

As used herein, the term “mouthfeel” refers to the sensation or sum of sensations other than taste or odor created by food or drink in the mouth.

As used herein, the term “taste experience” refers to a holistic experience involving taste sensation, mouthfeel and aromatic sensation. The taste experience refers to a “cross-modal” taste experience, or multidimensional sensorial attributes, meaning the experience whereby there is an “explosion of flavor” in the mouth, when substances/products are tasted in many places at once, in contrast to a one-dimensional experience.

As used herein, the term Koku (used interchangeably with the term “Kokumi”), refers to a sensation which can be described as a perceived richness, complexity of taste and flavor, viscosity, mouth-coating, and roundness that enhances thickness, continuity, complexity, freshness, and mouthfeel-ness of foods and beverages.

Advantageously, the herein disclosed flavor materials are characterized by providing a long-lasting pleasure and satisfaction that is typical to the experience of consuming foods that contain and/or are prepared with animal protein but is not present in the consumption of plant-based products, in particular so called “meat analogues”, and products prepared with industrial flavor solutions attempting to emulate the characteristics of animal protein. Without being bound by any theory, this may be due to a combination of (a) emotional experiences, (b) the fact that taste receptors exist throughout the human digestive system such that in essence, one continues to taste and experience the food that has been eaten long after finishing eating, and (c) the complex, mostly heretofore unexplored interactions between taste and aroma materials and the human microbiome.

As an additional advantage, the herein disclosed flavor materials may have “masking” and/or “blocking” capability, i.e. the ability to mask bitter and/or “off” flavors such as “beany” flavors and/or to block taste receptors so that bitterness and/or beany off flavors are perceived at a lower level than would be expected otherwise, a quality which is advantageous as unpleasant bitter and/or “off”, and or “beany” flavors are often found in plant-based meat replacement and/or other animal protein replacement products as well as many other foodstuffs.

According to further embodiments, the herein-disclosed flavor materials can further advantageously mask, decrease or block various off-flavor sensation when used in a variety of food products; and/or has the ability to facilitate taste modulation.

In some embodiments, the flavor materials possess the ability to mask, decrease and/or block the off-flavor typical to alternative sweeteners such, as stevia, in variety of reduced sugar food products (applications). Stevia extracts, for example, contain steviol glycosides, which are considered to be high-intensity sweeteners (with sweetness of about 250-300 times that of sucrose) and have been used as a sweetener for a range of food products. All steviol glycosides are bitter at different levels. Stevia delivers a sweet taste profile below 200-300 ppm and becomes bitter above 300 ppm and in beverage applications, it might have astringent and metallic properties, thus affecting mouthfeel.

In some embodiments, as exemplified herein, the disclosed flavor materials have the ability to facilitate sweetness modulation which improves a sugar-like mouthfeel in reduced sugar applications and also has the ability to mask the bitter and off-flavor of steviol glycosides.

In additional embodiments, advantageously, the herein-disclosed flavor materials may have “masking” and/or “blocking” capability of “astringency”. Astringency is a sensation in the mouth that is usually described as a shrinking, drying-out, stretching, and wrinkling feeling. Astringency can be felt in tasting un-ripen, fruits as well as in soy-based yogurt, other plant-based applications, and other types of food products.

In additional embodiments, advantageously, the herein-disclosed flavor materials may have “masking” and/or “blocking” capability of sour taste. Sourness is an important taste in many foods and drinks. Acidulants are added in many food products (applications) not only as a flavor but also as an antiseptic agent, antibacterial, preservative, and/or buffering activity However, the addition of an acidulant may cause a decrease in pH and a change in the taste balance, in addition to unpleasant sourness. Without being bound to any theory or mechanism, the herein-disclosed flavor material contains a large number of acids and a complex collection of sugars, this complexity having the capability of masking sourness, as further exemplified hereinbelow.

Moreover, in further embodiments, the herein-disclosed flavor materials have the ability to return the complexity and deeper taste in reduced salt food products.

Without being bound to any theory or mechanism, the herein disclosed flavor materials are rich in umami materials and other, amino acids, and in koku peptides and can consequently be useful when added to reduced salt food products, including without limitation condiments.

Moreover, the herein-disclosed flavor materials may in some embodiments provide a “mouthfeel” which is reminiscent of the mouthfeel provided by some foodstuffs containing animal protein. This mouthfeel may be achieved by delivering a perception of fat/fattiness/the presence of collagen resembling that of meat and/or fat and/or other animal protein, and/or—when claimed flavor materials are added to a foodstuff—by creating the impression that the said foodstuff contains a higher degree of fat and/or collagen than it actually does (“fat perception modulation”). All this while in fact the flavor material itself contains less than 5% and in some embodiments less than 2% or less than 1% fat.

In addition, in some embodiments, the herein-disclosed flavor materials can improve creaminess and milk fatty mouthfeel. Creaminess plays a unique role in the consumption experience due to its multidimensional textural attribute sensed during the consumption of some foods and beverages generated by mouthfeel. Thus, the herein-disclosed flavor materials can improve creaminess perception in plant-based milk and related food products, including nutritional drinks, without increasing fat percentages.

As used herein, the terms “substance” and “compound” may be used interchangeably and refer to a species of matter of definite chemical composition. According to some embodiment, the substance is an organic compound or molecule.

As used herein, the terms “non-volatile substance” and “NVS” may be used interchangeably and refer to substances that do not evaporate or sublimate at temperatures below 40° C. Each possibility is a separate embodiment. Non-volatile substances exhibit a low vapor pressure and a high boiling point. Sugars and salts are examples of non-volatile substance.

As used herein, the term “internal standard respective ratio (IRR) refers to the respective ratio of the peak area of a given substance (when measured using mass spectrometry-based analytical chemistry technology) to the peak area of the internal standard 13-sorbitol (in non-volatiles analysis), or Isobutylbenzene (for volatile analysis) measured when the flavor material(s) is concentrated such that their Brix value is approximately 60° Bx to 80° Bx or a Brix value of 65° Bx to 75° and/or their water content (moisture level) is approximately 40% to 60% or between approximately 45% to 55%).

As used herein, the terms “volatile substance”, “volatile organic substance” and “VOC” may be used interchangeably and refer to substances/substances that readily evaporate at-temperatures below 40° C. Each possibility is a separate embodiment. Volatile substances have higher vapor pressures versus non-volatile substances at the same temperature. VOC includes substances/substances responsible for the odor of scents and perfumes as well as pollutants.

As used herein, the terms “odor activity value” and “OAV” may be used interchangeably and refer to a measure of the importance of a specific substance to the odor of a sample (e.g. food). It is calculated by dividing the concentration of each individual substance by its odor detection threshold, i.e. the lowest concentration of odor that can be detected in the sample. According to some embodiments, the OAV refers to a measure obtained when the flavor material(s) is concentrated such that their Brix value is approximately 60° Bx to 80° Bx and/or their water content (moisture level) is approximately 40% to 60%. As used herein, a substance having an OAV above 10 (when the flavor material(s) is/are concentrated such that their Brix value is approximately 60° Bx to 80° Bx or a Brix value of 65° Bx to 75° and/or their water content (moisture level) is approximately 40% to 60% or between approximately 45% to 55%) is referred to herein as a “key odorant” i.e. a substance that significantly contributes to the aroma of a given product. Substances having an OAV (when the flavor material(s) is concentrated such that their Brix value is approximately 60° Bx to 80° Bx or a Brix value of 65° Bx to 75° and/or their water content (moisture level) is approximately 40% to 60% or between approximately 45% to 55%) between 1-10 are referred to herein as “notes”, i.e. substances that are not key odorants, but which can be sensed.

In general, all referral to values (e.g. OAV, IRR or compound concentration) refer to values obtained when the flavor material(s) is concentrated such that their Brix value is approximately 60° Bx to 80° Bx or a Brix value of 65° Bx to 75° or a Brix value of about 05° Bx to 55°, and/or the water content (moisture level) is between about 40% to 60% or between about 45% to 55%.

As used herein, the term “at least one” with regards to volatile and non-volatile substances may refer to 1, 2, 3, 4, 5, 6, 7, 8, 9, 10 or more substances. Each possibility is a separate embodiment. As a non-limiting example, the flavor material may include both Hexadecanoic acid and 2,3-Octanedione.

In some embodiments, the consumable flavor material, may include one or more of the volatile substances 2,3-Octanedione, 3-methyl-Butanal, 2-methyl-Butanal, 2,6-dimethyl-Pyrazine, a-ethylidene-Benzeneacetaldehyde, dimethyl Trisulfide, 1H-indole, 2-Propenal, Hexanal and/or Hexadecanoic acid, ethyl ester at an odor activity value (OAV) of at least 10.

In some embodiments, the consumable flavor material, may include one or more of the volatile substances 2,3-Octanedione, 1H-indole, 2-Propenal, Hexanal and/or Hexadecanoic acid, ethyl ester at an odor activity value (OAV) of at least 10 or at least 20.

In some embodiments, the consumable flavor material, may include one or more of the volatile substances 2,3-Octanedione, 3-methyl-Butanal, 2-methyl-Butanal, 2,6-dimethyl-Pyrazine, a-ethylidene-Benzeneacetaldehyde, and/or dimethyl Trisulfide at an odor activity value (OAV) of at least 10, at least 20 or at least 40.

According to some embodiments, the at least one volatile substance may be selected from 2,3-Octanedione, 1H-indole, Ethyl linoleate, Acetaldehyde phenyl-dimethyl acetal, 2,3-Butanediol, Hexanal, (2E)-5-methyl-2-phenyl-2-hexenal, Benzaldehyde, Hexadecanoic acid, ethyl ester, Benzoic Acid, 2-Propenal, Hexanal, 2-phenylpropenal, Propanoic acid, methyl ester, 3-methyl-Butanal, 2-methyl-Butanal, 2,6-dimethyl-Pyrazine, a-ethylidene-Benzeneacetaldehyde, dimethyl Trisulfide, or any combination thereof. Each possibility is a separate embodiment.

According to some embodiments, at least one-volatile substance may be selected from 2,3-Octanedione, 1H-indole, 2-Propenal, Hexanal, Hexadecanoic acid, ethyl ester, Ethyl linoleate, Acetaldehyde phenyl-dimethyl acetal, 2,3-Butanediol, 3-methyl-Butanal, 2-methyl-Butanal, 2,6-dimethyl-Pyrazine, a-ethylidene-Benzeneacetaldehyde, dimethyl Trisulfide, or any combination thereof. Each possibility is a separate embodiment.

According to some embodiments, least one volatile substance having a OAV above 5, may be selected from 2,3-Octanedione, 1H-indole, Hexanal, Benzaldehyde, (2E)-5-methyl-2-phenyl-2-hexenal, Hexadecanoic acid, ethyl ester, Benzoic Acid, 2-Propenal, Propanoic acid, methyl ester, 3-methyl-Butanal, 2-methyl-Butanal, 2,6-dimethyl-Pyrazine, a-ethylidene-Benzeneacetaldehyde and dimethyl Trisulfide.

According to some embodiments, the at least one volatile substance is 2,3-Octanedione.

According to some embodiments, the at least one volatile substance may have an odor activity value (OAV) of at least 5, at least 10, at least 20, at least 50, at least 100, at least 200, at least 500, or at least 1000. Each possibility is a separate embodiment. It is understood that, when the flavor material includes a multiplicity of volatile substances, each substance may have a different OAV. As a non-limiting example, the flavor material may include 2,3-Octanedione at an OAV of at least 10, at least 20, at least 40 or at least 50. Each possibility is a separate embodiment.

According to some embodiments, the OAV of the 2,3-octanedione is at least 40.

According to some embodiments, the flavor material comprises at least about 60%, at least about 65%, at least about 70% or at least about 80% non-volatile taste substances having a sweet taste out of the total amount of non-volatile taste substances (i.e., sweet, bitter, sour and umami). Each possibility is a separate embodiment.

According to some embodiments, the flavor material comprises at least about 5% w/w, at least about 10% w/w or at least about 15% w/w non-volatile taste substances having a sweet taste. Each possibility is a separate embodiment.

According to some embodiments, the taste distribution of sweet substances is in a range of 150-450 IRR, preferably in a range of 200-350 IRR.

According to some embodiments, the taste substances having a sweet taste may be selected from alanine, proline, fructose, rhamnose, asparagine, serine, mannitol, sucrose, glutamine, threonine, myo-inositol, glycine, glucose and raffinose or any combination thereof. Each possibility is a separate embodiment.

According to some embodiments, the taste substances having a sweet taste are selected from isomaltose, xylulose, sorbitol, mannitol, myo Inositol, fructose and sorbose or any combination thereof. Each possibility is a separate embodiment.

According to some embodiments, the taste substances having a sweet taste are selected from alanine, glycine, glucose, raffinose, rhamnose, myo-inositol and sucrose or any combination thereof. Each possibility is a separate embodiment.

According to some embodiments, the taste substances having a sweet taste comprise glucose and raffinose. According to some embodiments, the taste substances having a sweet taste comprise glucose.

According to some embodiments, the sweet taste substance comprises glucose with a concentration of at least about 2% w/w, at least about 3% w/w, at least about 4% w/w or at least about 4.5% w/w. Each possibility is a separate embodiment.

According to some embodiments, the taste distribution of sour substances is in a range of 30-100 IRR, preferably in a range of 40-90 IRR.

According to some embodiments, the flavor material comprises at least about 3%, at least about 4%, at least about 5%, at least about 6%, at least about 7%, at least about 10% or at least about 12% non-volatile taste substances having a sour taste out of the total amount of non-volatile taste substances (i.e., sweet, bitter, sour and umami). Each possibility is a separate embodiment. According to some embodiments, the flavor material comprises no more than about 30%, no more than about 25%, no more than about 20%, no more than about 10%, no more than about 7% or no more than about 5% non-volatile taste substances having a sour taste out of the total amount of non-volatile taste substances (i.e., sweet, bitter, sour and umami). Each possibility is a separate embodiment.

According to some embodiments, the flavor material comprises at least about 0.2% w/w, at least about 0.3% w/w, at least about 0.4% w/w, or at least about 0.45% w/w non-volatile taste substances having a sour taste. Each possibility is a separate embodiment.

According to some embodiments, the taste substances having a sour taste may comprise one or more of lactic acid 3-phenyl, Quinic acid lactic acid, citric acid, malic acid, succinic acid and tartaric acid, or any combination thereof. Each possibility is a separate embodiment.

According to some embodiments, the taste substances having a sour taste includes lactic acid. According to some embodiments, the flavor material includes lactic acid at an IRR of at least 25, at least 40 or at least 50. Each possibility is a separate embodiment.

According to some embodiments, the taste substances having a sour taste comprises lactic acid, and/or lactic acid 3-phenyl.

According to some embodiments, the sour taste substance comprises lactic acid at a concentration of at least about 0.2% w/w, at least about 0.3% w/w or at least about 0.4% w/w. Each possibility is a separate embodiment.

According to some embodiments, the taste distribution of bitter substances is in a range of 30-100 IRR, in a range of 40-100 IRR, in a range of 40-60 IRR or in a range of 60-100 IRR. Each possibility is a separate embodiment.

According to some embodiments, the flavor material comprises at least about 3%, at least about 5%, at least about 7%, at least about 10%, at least about 12%, at least about 15%, non-volatile taste substances having a bitter taste out of the total amount of non-volatile taste substances (i.e., sweet, bitter, sour and umami). Each possibility is a separate embodiment. According to some embodiments, the flavor material comprises no more than about 30%, no more than about 25% no more than about 20%, no more than about 10%, no more than about 7%, no more than about 6% or no more than about 5% non-volatile taste substances having a bitter taste out of the total amount of non-volatile taste substances (i.e., sweet, bitter, sour and umami). Each possibility is a separate embodiment.

According to some embodiments, the flavor material comprises at least about 0.2%, at least about 0.3% w/w, at least about 0.4% w/w or at least about 0.5% w/w non-volatile taste substances having a bitter taste. Each possibility is a separate embodiment.

According to some embodiments, the bitter taste substance is an amino acid.

According to some embodiments, the taste substances having a bitter taste may comprise one or more of: arginine, cystine, histidine, isoleucine, leucine, lysine, methionine, phenylalanine, tryptophan, tyrosine, valine, and any combination thereof. Each possibility is a separate embodiment.

According to some embodiments, the taste substances having a bitter taste comprise arginine, cystine, histidine, isoleucine, leucine, lysine, methionine, phenylalanine, tryptophan, tyrosine and valine and any combination thereof.

According to some embodiments, the taste substances having a bitter taste comprise arginine.

According to some embodiments, the bitter taste substance comprises arginine with concentration of at least about 0.1% w/w, at least about 0.15% w/w or at least about 0.2% w/w. Each possibility is a separate embodiment.

According to some embodiments, the taste distribution of umami substances is in a range of 7-50 IRR or in a range of 10-40 IRR.

According to some embodiments, the flavor material comprises at least about 3%, at least about 5%, at least about 6%, at least about 8%, at least about 10% or at least about 12% non-volatile taste substances having an umami taste out of the total amount of non-volatile taste substances (i.e., sweet, bitter, sour and umami). Each possibility is a separate embodiment. According to some embodiments, the flavor material comprises no more than 20%, no more than 15% no more than 12%, no more than 10%, no more than 9%, no more than 8% or no more than 7% non-volatile taste substances having a bitter taste out of the total amount of non-volatile taste substances. Each possibility is a separate embodiment.

According to some embodiments, the flavor material comprises at least about 0.6% w/w, at least about 0.7% w/w or at least about 0.8% w/w non-volatile taste substances having an umami taste. Each possibility is a separate embodiment.

According to some embodiments, the umami taste substance is an amino acid.

According to some embodiments, the umami taste substance comprises aspartic acid (aspartate), glutamic acid and betaine. Each possibility is a separate embodiment.

According to some embodiments, the umami taste substance comprises glutamate.

According to some embodiments, the umami taste substance comprises glutamate at a concentration of at least about 0.4% w/w, at least 0.5% w/w or at least 0.6% w/w. Each possibility is a separate embodiment.

According to some embodiments, the flavor material comprises aspartic acid at an IRR of at least 10, at least 15 or at least 20. Each possibility is a separate embodiment.

According to some embodiments the koku sensation substances may comprise one or more of Aspartate-Proline, Cysteine-Methionine-Threonine, y-Glutamyl-Aspartate, y-[Glu]3-Methionine, y-[Glu]2-Phenylalanine, y-Glutamyl-Glutamate, y-Glutamyl-Tyrosine and Glycine-Histidine-Glycine-Aspartate, or any combination thereof. Each possibility is a separate embodiment.

According to some embodiments, there is provided a consumable composition that has a meaty flavor, and/or is able to impart such flavors to other food stuff, the composition comprising the flavor rich flavor material disclosed herein.

According to some embodiments, the composition further comprises a flavor base in which the flavor material is blended with additional materials in order to create particular flavor profiles, which may be geared towards particular food applications. According to some embodiments, the flavor base is plant-based (vegetarian/vegan).

As used herein, the term “flavor base” refers to a combination of all the usual art-recognized ingredients required for the particular consumable composition including the composition detailed above, in additional to other consumable materials such as fruit and/or vegetable concentrates, wine concentrate, yeast products, yeast extracts, natural flavor materials, spices, extracts, botanicals, salt, and the like.

According to some embodiments, there is provided a method for producing a meatless or animal-protein free food product, the method comprising the addition of the consumable flavor-rich flavor material or the composition disclosed herein, to the meatless food product.

According to some embodiments, there is provided a meatless food product comprising the consumable flavor rich flavor material and/or the product bases (flavor bases) disclosed herein.

According to some embodiments, the meatless/animal protein free food product may be a ready-to-cook food product. According to some embodiments, the ready-to-cook food product may be an analogue of a form of animal product, including without limitation meat-less ground “meat” (also referred to as “mince”), meatless burgers, meatless “meat” balls, a meatless “chicken” product, such as nuggets, tenders, breasts, strips, cutlets, etc. a meatless “beef”, “pork”, “lamb” “fish” or other animal product, a product which is a plant-based analogue of a product which traditionally is derived from animal protein, a traditional meat analogue such as tempeh, tofu, seitan, yuba, and so on, a plant-based product which may be traditionally prepared with some form of animal protein which imparts typical flavors and sensorial experiences to said product, a plant-based stock, broth, bouillon, or similar which aims to be a plant-based analogue of similar products derived from animal sources (e.g. beef stock, chicken stock, pork stock, dashi, fish sauce, etc.) and to impart similar attributes, prepared foods (such as soups, sauces, stews, legume and/or grain based dishes, pastas, etc.) which traditionally might be prepared using any number of animal-based materials, pasta dishes and pasta sauces, cooking flavor-bases, dairy-free products which aim to impart the sensorial experience traditionally provided by dairy products, hot and cold sauces, table sauces, condiments, ready-to cook vegan or vegetarian dishes, chilled or frozen vegetarian/vegan dishes, or the like. Each possibility is a separate embodiment.

According to some embodiments, there is provided a food product comprising the consumable flavor rich flavor material and/or the product bases (flavor bases) disclosed herein. Such food product may include any type of food product, in any form (for example, liquid, semi liquid, hard, soft, etc.). In some embodiments, the food product is not a meatless food product.

According to some embodiments, the flavor materials disclosed herein are produced by a process of fermentation.

In some embodiments, the flavor materials disclosed herein are produced by a process of fermentation of legumes and/or grains and/or agro-industrial waste streams.

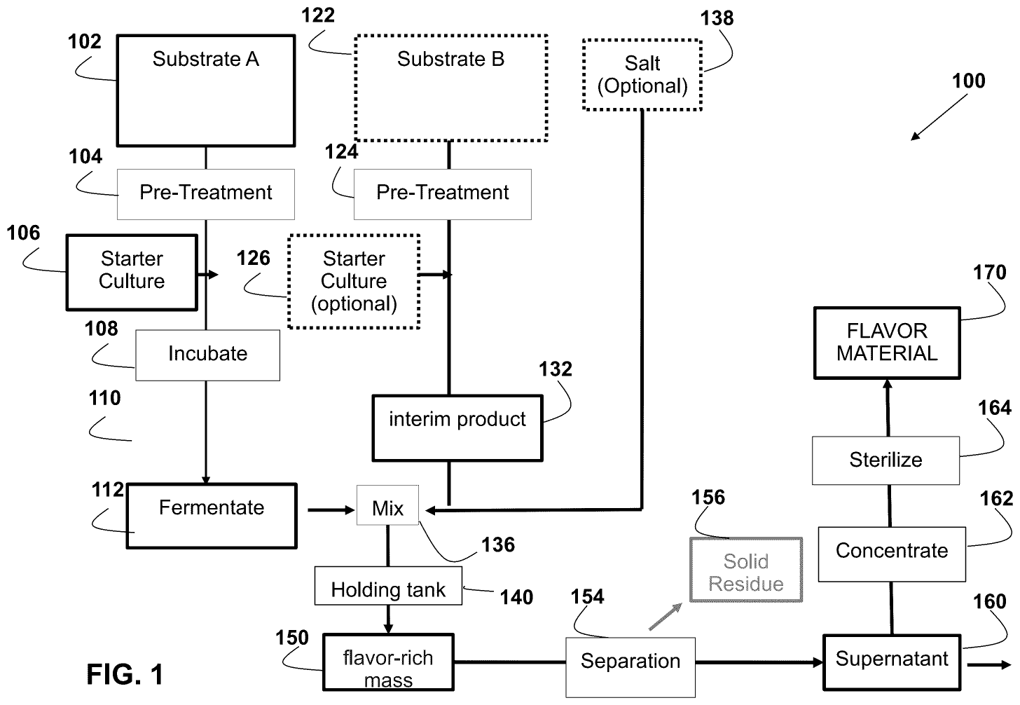

Reference is now made to FIG. 1, which is a schematic illustration of a process 100 for the preparation of a flavor material 170, according to some embodiments. As shown in FIG. 1, a first substrate (“substrate A” 102, which can be, for example, a legume and/or grain), is incubated at stage 108, (optionally after a pre-treatment (106) stage), in the presence of a starter microorganism culture (“starter culture” 104) under specified conditions, to produce biocatalyst 110. Optionally, a second substrate (“Substrate B” 122 (which may be similar or different than substrate A)) may undergo a process (which may be similar, identical or different with respect to any of the microorganisms used and/or other process conditions), including incubation with starter culture 124, after optional pretreatment stage 126, to produce an interim product 132. The interim product is mixed at stage 136 with fermentate 110 and/or salt 138 (such as, NaCl) and undergoes a period of holding at stage 140 under suitable conditions, to produce a flavor-rich mass 150. The resulting mass 150 may then be separated at stage 154 (by any suitable means such as decantation, press, centrifugation, etc.), to a solid residue fraction 156 and to a supernatant fraction 160. The supernatant 160 may then be concentrated at stage 162 (by any suitable means, such as freeze concentration, membrane-based concentration, dialysis, concentration columns, evaporation, distillation and the like) and optionally treated by heat or other means (e.g. pasteurized or sterilized) at stage 164, to result in flavor material 170.

In some embodiments, the substrate may be, for example, legumes and/or grains and/or seeds, nuts, and/or plant, and/or vegetable, and/or fruit, and/or a product produced using one or more of the above, and/or agro-industrial waste produced during the processing of one or more of the above.

In some embodiments, the legumes may include, for example, but not limited to: chickpeas, lentils, peas, black beans, green beans, kidney beans, blacked-eyed, navy beans, lupin, green lentils, black lentils, red/yellow lentils, green peas, yellow peas, bambara nut, or any combinations thereof. Each possibility is a separate embodiment.

In some embodiments, the grains may be selected from, but not limited to: wheat, einkorn, emmer, farro, Khorasan wheat (“Kamut”), rye, oat, rice, corn (maize), barley, buckwheat, quinoa, teff, amaranth, spelt, freekeh, Sorghum, millet, fonio, or any combinations thereof. Each possibility is a separate embodiment.

In some embodiments, the seeds may be selected from, but not limited to: flaxseeds, chia seeds, hemp seeds, sesame seeds, pumpkin seeds, sunflower seeds, rapeseed, palm kernel, coconut, copra, cottonseed, rapeseed, safflower, olive, and the like, or any combinations thereof. Each possibility is a separate embodiment.

in some embodiments, the nuts may be selected from, but not limited to: macadamia nuts, brazil nuts, walnuts, hazelnuts, pecan nuts, chestnuts, peanuts, cashew nuts, almonds, and the like, or any combinations thereof. Each possibility is a separate embodiment.

In some embodiments, the plant or vegetable may be selected from, but not limited to: leeks, radish, celeriac, turnip, spinach, chard, kale, pepper, parsnip, onion, tomato, celery, grapes, potatoes, garlic, beet, carrot, and the like, or any combinations thereof. Each possibility is a separate embodiment.

In some embodiments, the fermentation process is performed in the presence of one or more types of microorganisms.

According to some embodiments, the microorganism(s) may be selected from, but not limited to various species and strains of fungi and bacteria. In some embodiments, the fungi may be selected from the fungal division of Ascomycota, fungal division of Basidiomycota, fungal class of Sacchromycetes, or combinations thereof. In some embodiments, fungi selected from the fungal division of Ascomycota may include any strains of Aspergillus spp. (such as, but not limited to: A. oryzae, A. sojae, A. luchensis, and/or A. niger, any strain of Rhizopus spp, Trichoderma spp, Fusarium spp, Penicillium spp, and/or Neurospora spp. Each possibility is a separate embodiment.

In some embodiments, fungi selected from the fungal division of Basidiomycota may include any strains from the Agaricomycetes class, such as but not limited to Agaricus spp., Amanita spp. Armaillaria spp., Pleurotus spp., Pluteus spp., Grifola spp., Hydnum spp., Hygrophorus spp., Lentinuts spp., Lepiota spp., Ramaria spp., Russula spp., Sparassis spp., Tricholomoa spp., Tuber spp., Volvariella spp., Each possibility is a separate embodiment.

In some embodiments, the bacteria may be selected from a bacteria of the Bacilli class (including any non-toxic strains of the Bacillales, Caryophanales, Desulfuribacillales and Lactobacillies orders, and/or any non-toxic strains of Actinomycetaceae, Brevibacteriaceae and Micrococcaceae). In some embodiments, the bacteria may be selected from a bacteria belonging to the Actinomycetia class, or any combinations thereof. Each possibility is a separate embodiment.

According to some embodiments, the salt may be selected from sodium chloride, potassium chloride, calcium chloride, sodium bisulfate, copper sulfate, magnesium sulfate, and the like, or any combinations thereof. Each possibility is a separate embodiment.

According to some embodiments, the incubation conditions may be selected from: incubation time (length), temperature, humidity, oxygen and/or CO₂ concentration, light regime, air flow, presence or absence of agitation, agitation type and speed, characteristics of growth vessels (containers) and agitation devices, and the like.

In some embodiments, the incubation time may be in the range of about 8-126 hours, or any subranges thereof, such as, for example, 10-40 hours, 20-60 hours, 30-100 hours, and the like.

In some embodiments, the incubation temperature may be in the range of about 20-55° C., or any subranges thereof, such as, for example, 25-35° C., 30-40° C., 30-50° C. and the like. In some embodiments, the relative humidity may be in the range of about 40-99%, or any subranges thereof, such as, for example, 40-60%, 50-70%, 60-80%, 70-90%, 65-85% and the like.

In some embodiments, the oxygen concentration may be in the range of about 0-97%, or any subranges thereof, such as, for example, 0-15%, 10-20%, 25-35%, 50-60%, 70-82%, and the like.

In some embodiments, the holding stage may be in the length of about 1-365 days, or any subranges thereof, such as, for example 1-100 days, 50-200 days, 100-300 days, and the like.

In some embodiments, the holding stage may be performed at a temperature in the range of about 4-70° C., or any subranges thereof, such as, for example, 10-50° C., 15-45° C., 20-40° C., and the like.

According to some embodiments, the concentration may include the use of concertation columns, centrifugation, dialysis, freeze concentration, membrane separation, filters, evaporation, distillation and the like.

According to some embodiments, the sterilization may include pasteurization of the flavor material, for example, by ultra-heat treatment (UHT), UV radiation, high pressure treatments and the like.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

In the following examples, OAV was calculated by dividing the compound concentration by its detection threshold. As elaborated above, the detection threshold is the lowest concentration of a certain odor compound that is perceivable by the human sense of smell.

Compound concentration is presented in parts per billion (ppb), e.g. 1 μg/L. The concentration was calculated using the standard curve of the internal standard isobutylbenzene.

Odor type and OAV were determined using the “Good Scents Company's” information system, which is currently the largest publicly-available body of relevant knowledge concerning the typical aromas of given substances for the flavor, food and fragrance industries. Information on odor was gathered by using the CAS (Chemical Abstracts Service) registry number of each compound. When absent from the Good Scents Company's data, OAV and odor type were determined by using previewed literature.

### Materials and Methods

### Analytical Analysis for Volatile Substances

For volatile analysis, 100 mg of the herein disclosed flavor products was weighted into a 20 ml glass vials (CleanVial, Chrom4, Thüringen, Germany), which also contained 1 ml of saturated Sodium chloride solution containing Isobutylbenzene (10 mg/L, Sigma-Aldrich, Israel as an internal standard. The volatile profiles were examined by headspace solid-phase microextraction (HS-SPME) coupled with GC-MS. Prior to analysis, glass vials were incubated for 15 min at 60° C. with PAL COMBI-xt (CTC Analytics AG Switzerland) to release free volatiles into the headspace. A 10 mm long SPME fiber, assembly 50/30 μm, divinylbenzene/carboxen/polydimethylsiloxane (Supelco, Bellefonte, PA, USA), was introduced into the headspace for 15 min at 60° C. The fiber was then desorbed for 10 min at 250° C. in splitless mode within the inlet of a 7890A GC (Agilent, Santa Clara, CA, USA) equipped with an VF-5 MS 10 m EZ guard capillary column (30 m×0.25 mm inner diameter, 0.25 μm film thickness; Agilent CP9013, USA), coupled to a 5977B MS detector (Agilent). Helium was the carrier gas in a constant pressure mode rate of 1 mL·min⁻¹, and the GC temperature was programmed for 40° C. (1 min), and increased to 250° C. at 6° C./min. Ionization energy was 70 eV with a mass acquisition range of 40-400 m/z, and a scanning rate of 6.34 spectra/s. Retention index (RI) was calculated by running C8-C20 n-alkanes. Data analysis was conducted Wiley 10 with NIST 2014 mass spectral library data using the Mass Hunter software package (version B.08.00, Agilent, USA). Further identification of major compounds was based on a comparison of mass spectra and the retention index. Quantitative evaluation was performed using internal standards; peak areas were normalized to the Internal standard (Isobutylbenzene 0.8 μg per sample.

### Analytical Analysis for Non-Volatile Substances

Non-volatile analysis was done using Liquid Chromatography-Mass Spectrometry (LC-MS). Samples preparation was conducted as follows: 20 mg (+/−1.5 mg) of each sample was weighted into a 2 ml Eppendorf tube and diluted with 1 ml of extraction mixture (Methanol: Acetonitrile: Water at a ratio of 5:3:2 respectively). The samples were vortexted using Precellys 24 homogenizer (6500 RPM, 3 cycles of 30 seconds with 10 seconds break in between). The samples were centrifuged for 15 minutes at 18,000 RPM, supernatant was collected and diluted further on x20 taking 50 ul of sup and diluting with 950 ul of metabolites extraction mix (same solution).

LC-MS metabolomic analysis was performed as described in Mackay G M, et al. (Analysis of Cell Metabolism Using LC-MS and Isotope Tracers. Methods Enzymol 2015, 561, 171-196, doi: 10.1016/bs.mie.2015.05.016); Briefly, Thermo Vanquish Flex ultra-high-performance liquid chromatography (UPLC) system coupled to an Orbitrap Exploris 240 Mass Spectrometer (Thermo Fisher Scientific) was used. Resolution was set to 120,000 at 200 mass/charge ratio (m/z) with electrospray ionization and polarity switching mode to enable both positive and negative ions across a mass range of 67-1000 m/z. UPLC setup consisted of a ZIC-PHILIC column (SeQuant; 150 mm×2.1 mm, 5 μm; Merck). Five ul of extracts were injected and the compounds were separated using a mobile phase gradient of 15 min, starting at 20% aqueous (20 mmol/L ammonium carbonate adjusted to pH 9.2 with 0.1% of 25% ammonium hydroxide): 80% organic (acetonitrile) and terminated with 20% acetonitrile. The flow rate and column temperature were maintained at 0.2 mL/min and 45° C., respectively, for a total run time of 27 min. All metabolites were detected using a mass accuracy below 1 ppm. Thermo Xcalibur 4.4 was used for data acquisition. TraceFinder™ 5.0 was used for data analysis. Peak areas of metabolites were determined by using the exact mass of the singly charged ions. The peak areas of different metabolites were determined using Thermo TraceFinder software, where metabolites were identified by the exact mass of the singly charged ion and by the known retention time, using an i MS library built by running commercial standards of all detected metabolites.

For Koku substances, identification was achieved by using the above-mentioned chromatographic method in combination with high resolution, accurate mass MS-MS experiments for spectral fingerprint identification. The obtained spectral fingerprint was matched to the known literature for ID confirmation.

### Sensory Assessment

Sensory assessment is a scientific field covering all techniques for eliciting, measuring, analyzing, and interpreting human reactions to food characteristics perceived by the 5 senses. It's particularly important when assessing the attributes of complex foods such as meat substitutes.

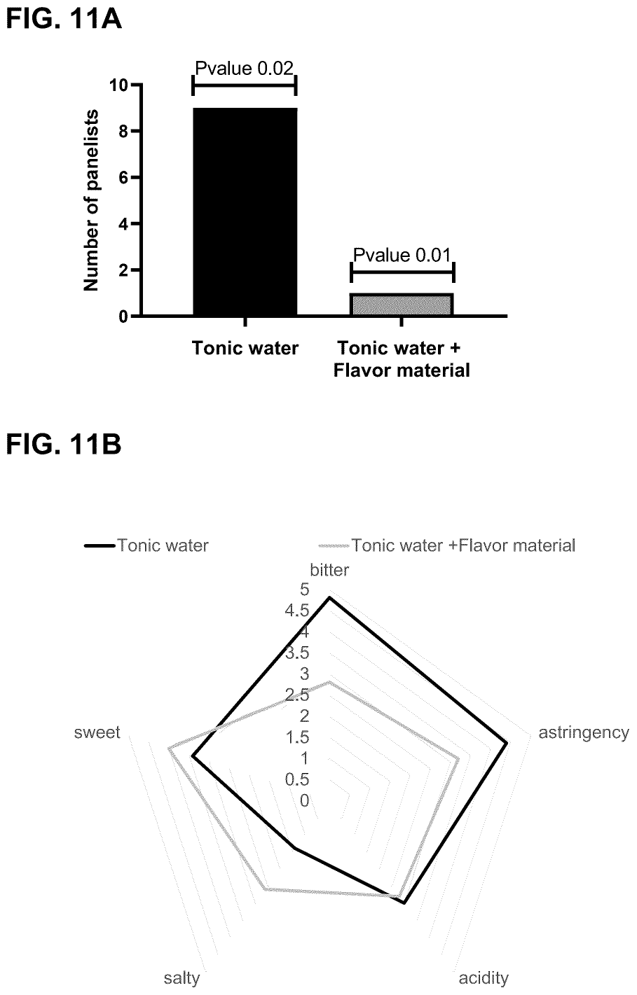

The herein disclosed flavor materials were sensory evaluated by two techniques:
1. 2-AFC (alternative forced choice), a type of paired comparison test, also known as a directional difference test. In this test, panelists were given two samples and directed to choose the one that has more of a given attribute, to assess which sample has the highest intensity on a particular characteristic. In each test, 10 panelists (tasting experts) were given two samples: 1. a reference sample, and 2. the reference sample with the addition of the herein flavor material product(s). Following each pairwise comparison test, panellists were asked to choose which sample of the two is more (or less) bitter, sour, astringent, has beany off-flavor, stevia off-flavor, has fat perception or mouthfeel perception. Collected data was analysed using the binomial distribution. The test was performed for three different FM samples. The results presented in FIGS. 10-14 show the average values of all three tested FMs.
2. QDA (Quantitative Descriptive Analysis), a descriptive analysis technique in sensory evaluation, for describing the intensity of product attributes. In each test, 5 expert panelists were given 4 samples: a reference sample (as is), and three reference samples, each containing different flavor material product FM1, FM 2 or FM3. Following each taste test, the panelists quantified, per each sample, the following taste sensations: salty, sweet, bitter, sour, and astringent. Collected data was used to generate Spider Graphs, which presented the average values for the 3 FMs tested.

### Example 1—Identification of Volatile Fingerprints of Flavor Materials (“FMs”) FM-1, FM-2, FM-3 and FM-4

Generally, the Flavor Materials were Produced Essentially as Shown in FIG. 1. Briefly:

Production of fermentate: A food matrix (substrate A) containing one or more plant materials (e.g. grains and/or legumes and/or seeds, nuts, and/or plant, and/or vegetable, and/or fruit, and/or a product produced using one or more of the above, and/or agro-industrial waste produced during the processing of one or more of the above) was sterilized and inoculated with one or more microorganisms (e.g. bacteria and/or fungi). The microorganism(s) were grown on said substrate for between 12 and 126 hours under controlled humidity, temperature and oxygen availability. For example, humidity was regulated at between 60 to 99% RH, the temperature was regulated between 2° and 55° C., and oxygen was regulated between 0 and 97%, with or without agitation, which in turn can be either continuous or intermittent.

In the examples shown herein, the substrates included legumes such as lentils, chickpeas, peas and beans, but similarly, other substrates may be used.

2. Preparation of secondary substrate (optional): the fermentate was mixed with additional plant matter (Substrate B) from the groups detailed above or other sources and other materials. This secondary substrate was stored in a controlled environment for between 1 and 365 days 3. Optionally additional microorganisms were added to conduct additional fermentation stages.

4. Finally, the dry matter was separated out using commonly known methods and the resulting solution (supernatant) was concentrated.

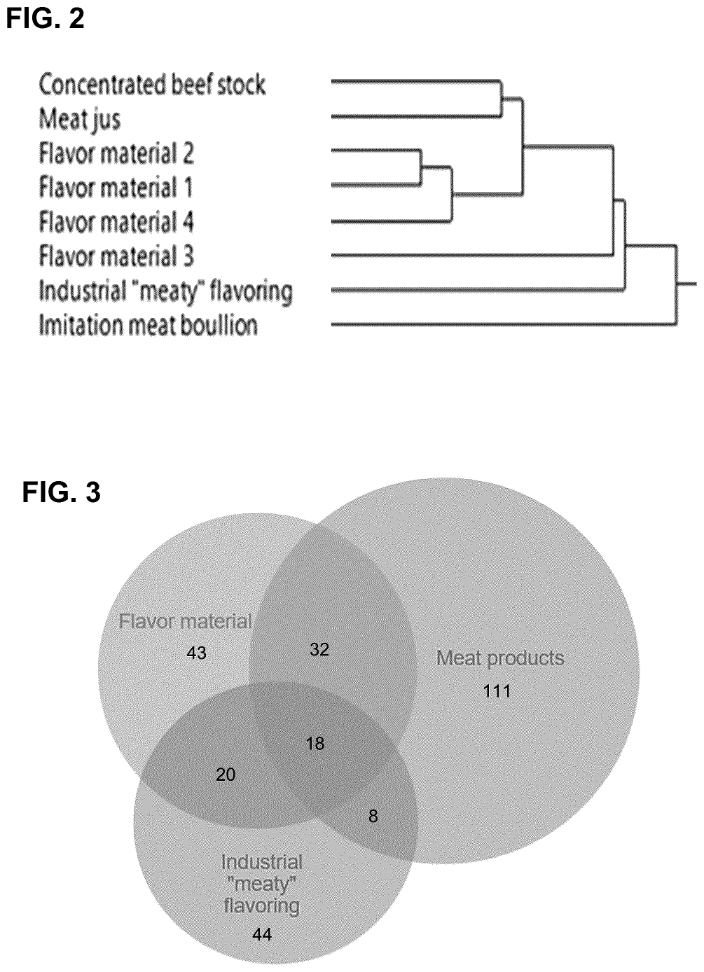

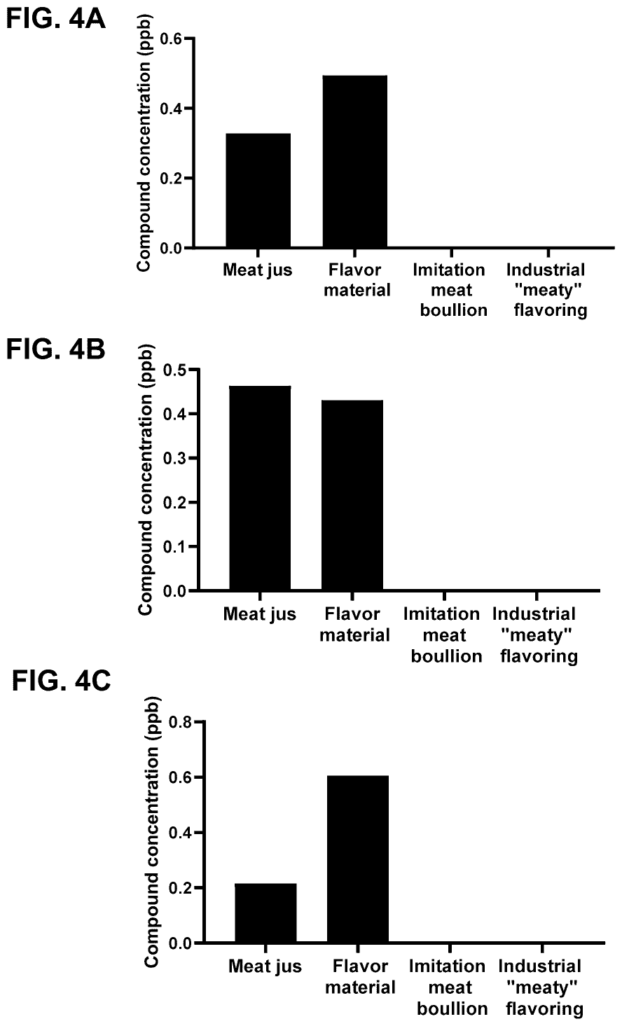

As can be seen from the dendrogram of FIG. 2, while being meat-less, the herein disclosed flavor materials 1˜4 cluster with meat products such as concentrated beef stock and meat jus as opposed to known non-meat flavors (industrial meaty flavoring and imitation meat bullion). Moreover, as seen from FIG. 3, the total amount of known volatile taste substances in the herein disclosed flavor materials resembles that of meat products (113 and 169, respectively) and is significantly higher than that of known non-meat products (here shown industrial meat flavoring (90)). Moreover, 50 out of the 113 (44%) volatile substances found in the herein disclosed flavor materials are common to those of meat products while only 26 (29%) of found in the industrial meat flavoring are shared with that of meat products.

As shown in Table 1 below, various volatile compounds were identified and their OAV was calculated.

TABLE 1
OAV of volatile compounds identified in flavor materials FM-1, FM-2 and FM-4.

| | | | | Compound | Compound |
|---|---|---|---|---|---|
| | | | OAV in | concentration | concentration |
| Compound | | | FM 1, 2 | in FM 1, 2 and 4 | in Meat |
| name | CAS | Odor Type | and 4 | [ppb]* | Products [ppb] |
| 1H-indole | 120-72-9 | animal | 0.144 | 0.09-0.25 | 0.00-0.46 |
| Benzoic Acid | 65-85-0 | balsamic | Not | 1.62-2.40 | 0.00 |
| | | | found | | |
| 2,3-Butanediol | 513-85-9 | cream | 0.00023 | 4.21-13.94 | 0.00 |
| or 1,3- | 107-88-0 | | | | |
| Buntanediol | | | | | |
| 2,3- | 585-25-1 | Dill | 53.76 | 0.60-0.87 | 0.21-29.70 |
| Octanedione | | | | | |
| Ethyl linoleate | 544-35-4 | Fatty | Not | 0.17-0.78 | 0.00 |
| | | | found | | |
| 2-Propenal | 107-02-8 | fruity | 0.17 | 0.00-0.59 | 0.00 |
| Propanoic acid, | 554-12-1 | fruity | 0.0050 | FM 1, 2: | 0.00-0.32 |
| methyl ester | | | | 0.49-0.83 | |
| Acetaldehyde, | 101-48-4 | green | Not | FM 4: | 0.00 |
| phenyl-, | | | found | 0.64 | |
| dimethyl acetal | | | | | |
| (2R,3R)-butane- | 24347-58-8 | Not found | | FM 1, 2: | 0.00 |
| 2,3-diol | | | | 23.61-65.12 | |
| Benzaldehyde | 100-52-7 | Fruity, almond, | 6.09 | 0.157-0.445 | 0.00-34.00 |
| | | nutty | | | |
| (E)-2-Decenal | 3913-81-3 | fried chicken | 0.768 | 0.00028-0.000393 | 0.00-131.00 |
| | | fat tallow | | | |
| 3-methyl- | 590-86-3 | chocolate | 114.65 | 0.065-0.176 | 0.00-187.00 |
| Butanal | | peach fatty | | | |
| 2,3- | 600-14-6 | pungent sweet | 0.042 | 0.0005-0.001 | 0.00-2.00 |
| Pentanedione | | butter creamy | | | |
| | | caramel nutty | | | |
| | | cheese | | | |
| 2-methyl- | 96-17-3 | nutty malty | 92.897 | 0.059-0.126 | 0.00-162.00 |
| Butanal | | fermented fatty | | | |
| 2,6-dimethyl- | 108-50-9 | roasted meaty | 485.53 | 0.005-0.302 | 0.00-15.00 |
| Pyrazine | | beefy brown | | | |
| 1-nonanol | 143-08-8 | Floral | 0.699 | 0.0005-0.001 | 0.00-61.00 |
| (2E)-5-Methyl- | 21834-92-4 | bitter cocoa | 6.434 | 0.051-0.278 | 0.00-0.00 |
| 2-Phenyl-2- | | nut skin | | | |
| Hexanal | | | | | |
| (2Z)-4-Methyl- | 26643-91-4 | sweet cocoa | 0.424 | 0.008-0.105 | 0.00-0.00 |
| 2-Phenyl-2- | | nutty | | | |
| Pentanal | | | | | |
| α-ethylidene- | 4411-89-6 | Musty, beany, | 3716.536 | 0.011-0.090 | 0.00-6396.00 |
| Benzeneacetaldehyde | | honey | | | |
| 2-Phenylpropenal | 4432-63-7 | fresh sharp | 4.181 | 0.002-0.006 | 0.00-0.00 |
| | | green | | | |
| dimethyl | 3658-80-8 | sulfurous cooked | 1213.98 | 0.004-0.032 | 0.00-11474.00 |
| Trisulfide | | onion savory | | | |
| | | meaty | | | |

*Values presents the range of the lowest and the highest concentrations.

As seen from Table 1, one substance was found at an average OAV of above 3700, namely a-ethylidene-Benzeneacetaldehyde. Other substances were found at an average OAV of above 1200, namely dimethyl Trisulfide, and at an average OAV of above 480, namely 2,6-dimethyl-Pyrazine and at an average OAV of above 110, namely 3-methyl-Butanal. Other key odorant substances include 2-methyl-Butanal with an average OAV of above 90 and 2,3-Octanedione, with an average OAV of above 50.

Other notable substances include (2E)-5-Methyl-2-Phenyl-2-Hexanal and Benzaldehyde, with an average OAV of above 6 each, and 2-Phenylpropenal with an average OAV above 4.

FM-3 had a distinct volatile profile, set forth in Table 2 below, which shows various volatile compounds identified in FM-3 and their calculated OAVs.

TABLE 2
OAV of volatile compounds identified in flavor material FM3.

| | | | | Compound |
|---|---|---|---|---|
| | | | Compound | concentration |
| | | OAV in | concentration | in Meat |
| Compound name | Odor Type | FM3 | in FM3 [ppb] | product [ppb] |
| (2E)-5-methyl-2- | chocolate | 1.01 | 504.05 | 0.00 |
| phenyl-2-hexenal | | | | |
| 1H-indole | animal | 22.42 | 67.26 | 0.00-0.46 |
| Benzoic Acid | balsamic | Not found | 441.38 | 0.00 |
| 2,3-Butanediol or | cream | 0.0053 | 316.28 | 0.00 |
| 1,3-Buntanediol 2 | | | | |
| 2,3-Octanedione | Dill | 6098.34 | 73.18 | 0.21-29.70 |
| Ethyl linoleate | fatty | | 124.60 | 0.00 |
| 2-Propenal | fruity | 60.82 | 218.94 | 0.00 |
| Propanoic acid, methyl ester | fruity | 1.39 | 138.87 | 0.00-0.32 |
| Hexanal | green | 45.82 | 187.84 | 78.72-363.57 |
| Acetic acid, phenyl-, | honey | 0.0032 | 325.94 | 0.00-1.44 |
| methyl ester | | | | |
| 2,3-Butanediol, | fruity creamy | Not found | 339.7 | 0.00 |
| | buttery | | | |
| Hexadecanoic acid, | waxy | Not found | 272.66 | 0.00 |
| methyl ester | | | | |
| Hexadecanoic acid, | waxy | 62.30 | 747.24 | 0.00 |
| ethyl ester | | | | |

As seen from Table 2, one substance was found at an OAV of above 6000, namely 2,3-Octanedione (also identified in FMs 1, 2 and 4 yet at a lower OAV, above 50). Two substances were found at an OAV of above 60, namely 2-Propenal and Hexadecanoic acid, ethyl ester. Another substance was found at an OAV of above 40, namely Hexanal (having a similar OAV as in meat). Other notable substances include (2E)-5-Methyl-2-Phenyl-2-Hexanal and Propanoic acid, methyl ester.

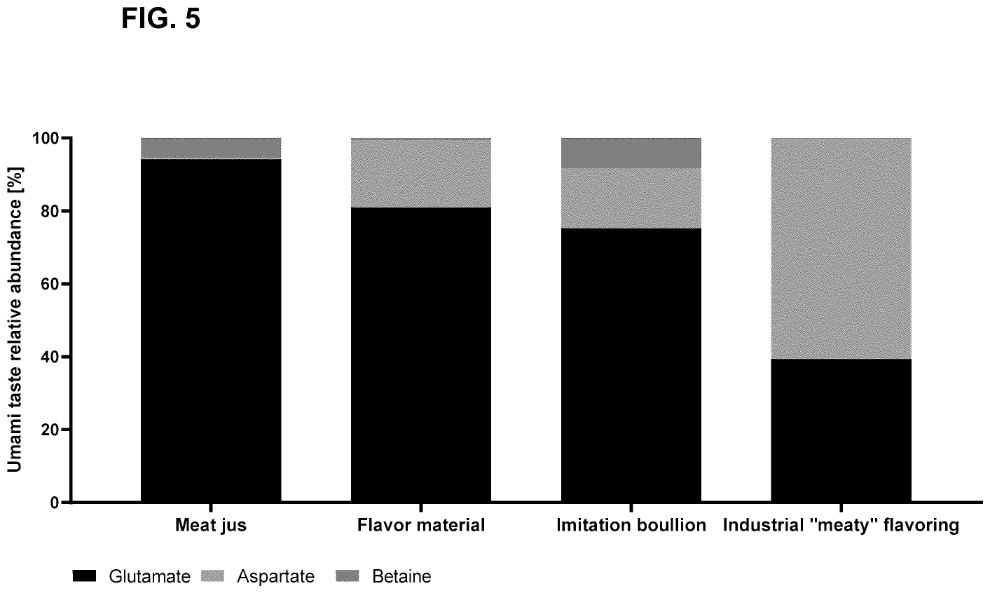

Interestingly, as seen from FIG. 4A-4C, three compounds, namely 2,3-Octanedione (key odor component in all of the herein disclosed flavor materials), 1H-indole and propanoic acid methyl ester were found at significant levels in the herein disclosed flavor material and in meat product, while being absent in known non-meat, meat imitation products.

### Example 2—Identification of Non-Volatile Fingerprints

In addition to the identification of a volatile substance fingerprint of the herein disclosed flavor materials, an analysis of the distribution of primary metabolites that create the taste of sweet, sour, bitter and umami was conducted.

### Umami Taste Components Distribution

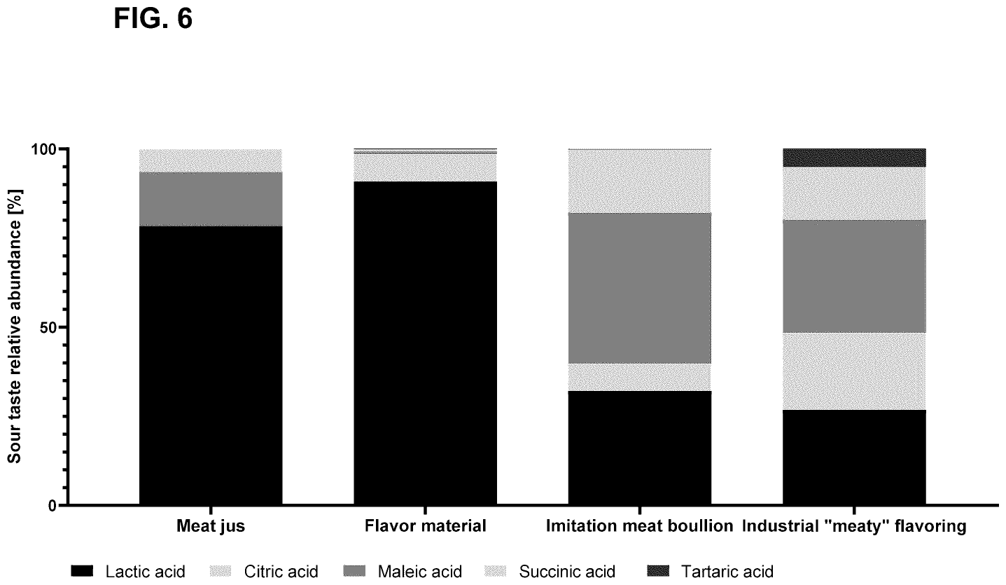

As seen from FIG. 5, when examining the distribution of umami substances, FM1-4 are characterized by a high amount of, glutamate and aspartate.

The umami molecules found in significant amounts in the herein disclosed flavor materials are set forth in Tables 3A and 3B below.

TABLE 3A
Umami molecules [IRR]

| Substance | FM 1-4 IRR | Meat products IRR |
|---|---|---|
| 5′-UMP | 1.06-2.64 | 0.00 |
| Aspartic acid | 13.89-23.53 | 0.07-2.74 |

TABLE 3B
Umami molecules [g/100 g product]

| | FMs 1-4 g/100 | Meat products |
|---|---|---|
| Substance | g product [% w/w] | g/100 g |
| Glutamate | 0.58 | 0.43 |
| Aspartate | 0.13 | 0.0021 |
| Betaine | 0.0043 | 0.0047 |
| Total (avg.): | 0.71 | 0.43 |
| Total (range): | 0.62-0.84 | 0.09-0.49 |

As further seen from FIG. 5, the herein disclosed flavor materials are characterized by having high levels of glutamate (about 80% out of the total umami substances), in resemblance to meat products (about 95% out of the total umami substances).

### Sour Taste Components Distribution

The sour molecules found in significant amounts in the herein disclosed flavor materials are set forth in Tables 4A and 4B below.

TABLE 4A
Sour compounds [IRR]

| Substance | FM 1-4 IRR | Meat products IRR |
|---|---|---|
| Lactic acid | 19.98-53.11 | 2.11-15.52 |
| Lactic acid, 3-phenyl | 0.99-3.76 | 0.00-0.03 |
| Quinic acid | 0.72-0.814 | 0.0011-0.0071 |
| Malic acid | 2.19-2.35 | 0.007-0.12 |

TABLE 4B
Sour compounds [g/100 g product]

| | FMs 1-4 g/100 | Meat products |
|---|---|---|
| Substance | g product [% w/w] | g/100 g |
| Lactic acid | 0.34 | 0.10 |
| Citric acid | 0.027 | 0.018 |
| Malic acid | 0.0025 | 0.0034 |
| Succinic acid | 0.0024 | 0.0082 |
| Tartaric acid | 0.00043 | 0.00028 |
| Total (avg.): | 0.37 | 0.13 |
| Total (range): | 0.31-0.45 | 0.05-0.15 |

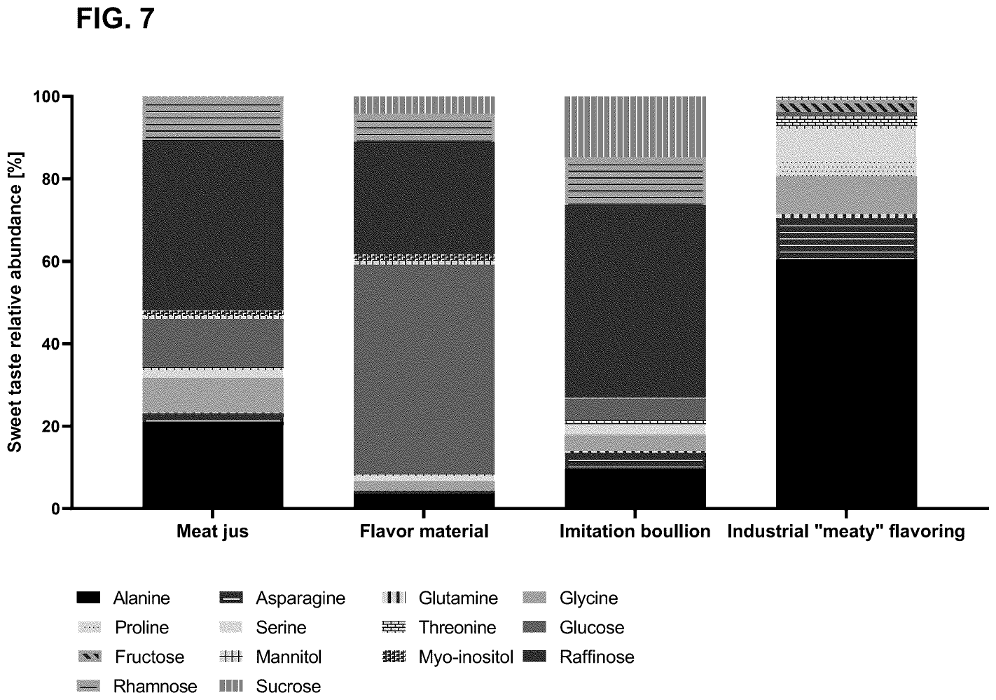

Advantageously, the “sour fingerprint” (FIG. 6) of the herein disclosed flavor materials shows that the distribution of different sour substances in the herein disclosed flavor materials resembles that of meat products (here shown meat jus). In particular, as in meat, the herein disclosed flavor materials contain high levels of lactic acids (about 90% out of the total sour substances), in resemblance to meat products (about 80% out of the total sour substances), and lower levels of malic and succinic acids, as compared to other meat-imitation products.

### Sweet Taste Components Distribution

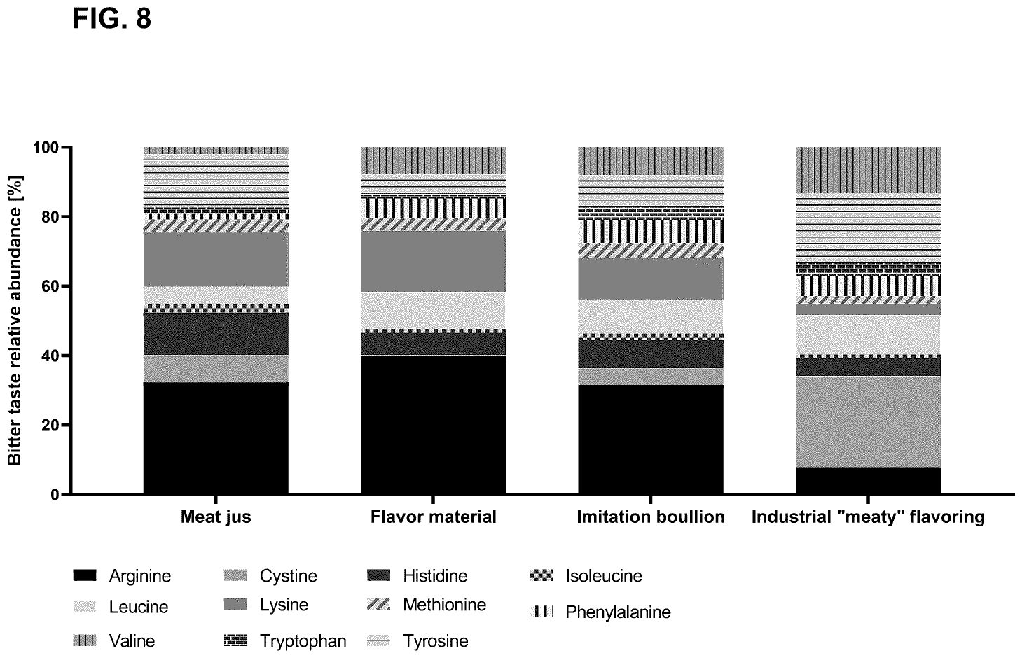

The sweet molecules found in significant amounts in the herein disclosed flavor materials are set forth in Tables 5A-5B below. A distinct “sweetness fingerprint” showing the distribution of different sweet substances in the herein disclosed flavor materials is shown in FIG. 7. Without being bound by any theory, the high concentration (and their variety, 14-17 different sweet substances) of sweet substances out of the total amount of non-volatile taste substances (i.e., sweet, bitter, sour and umami) may be what provides the masking/blocking property of the flavor material.

TABLE 5A
Sweet Compounds [IRR]

| Substance | FM 1-4 IRR | Meat products IRR |
|---|---|---|
| Isomaltose | 9.22-21.77 | 0.006-0.14 |
| Xylulose | 0.37-0.82 | 0.00-0.02 |
| Sorbitol | 1.0-2.22 | 0.002-0.05 |
| Mannitol | 6.10-8.41 | 0.00-0.44 |
| Inositol, myo | 6.33-10.39 | 0.41-3.43 |
| Fructose | 6.57-14.76 | 0.004-1.3 |
| Sorbose | 6.28-13.7 | 0.009-1.29 |
| Glutamine | 0.25-0.95 | 0.00-0.19 |
| L-rhamnose | 0.54-1.56 | 0.00-0.02 |
| Arabinose | 10.32-19.83 | 0.0083-0.21 |
| Ribose | 1.01-2.39 | 0.00-0.18 |
| Arabitol | 6.66-12.49 | 0.00-1.06 |
| Lactose | 1.66-3.68 | 0.00-0.03 |
| Cellobiose | 0.51-1.5 | 0.00-0.003 |
| Maltose | 0.53-4.39 | 0.0023-0.08 |
| Palatinose | 0.43-1.11 | 0.00 |
| Glucose | 31.06-56.97 | 0.08-1.96 |

TABLE 5B
Sweet Compounds [g/100 g product]

| | FMs 1, 2 and 4 | |
|---|---|---|
| | g/100 g product | Meat products |
| Substance | [% w/w] | g/100 g |
| Alanine | 0.23 | 0.067 |
| Asparagine | 0.048 | 0.0054 |
| Glutamine | 0.0047 | 0.0030 |
| Glycine | 0.14 | 0.027 |
| Proline | 0.034 | 0.0044 |
| Serine | 0.058 | 0.0054 |
| Threonine | 0.029 | 0.0061 |
| Glucose | 3.38 | 0.045 |
| Fructose | 0.00055 | 0.0041 |
| Mannitol | 0.056 | 0.00054 |
| myo-inositol | 0.11 | 0.00088 |
| Raffinose | 1.82 | 0.16 |
| Rhamnose | 0.45 | 0.042 |
| Sucrose | 0.27 | 0.075 |
| Total (avg.): | 6.64 | 0.45 |
| Total (range): | 5.00-7.00 | 0.36-1.37 |

### Bitter Taste Components Distribution

The bitter molecules found in significant amounts in the herein disclosed flavor materials are set forth in Table 6 below.

TABLE 6
Bitter compounds

| | Average in FMs 1-3 | |
|---|---|---|
| | g/100 g product | |
| | [% w/w] | Average in Meat Jus |
| Arginine | 0.17 | 0.15 |
| Cysteine | 0.0014 | 0.06 |
| Histidine | 0.027 | 0.034 |
| Isoleucine | 0.0041 | 0.0083 |
| Leucine | 0.046 | 0.017 |
| Lysine | 0.077 | 0.060 |
| Methionine | 0.015 | 0.016 |
| Phenylalanine | 0.024 | 0.011 |
| Valine | 0.038 | 0.021 |
| Tryptophan | 0.0035 | 0.0071 |
| tyrosine | 0.0206 | 0.0055 |
| Total (avg.): | 0.42 | 0.39 |
| Total (range): | 0.32-0.53 | 0.1-0.34 |

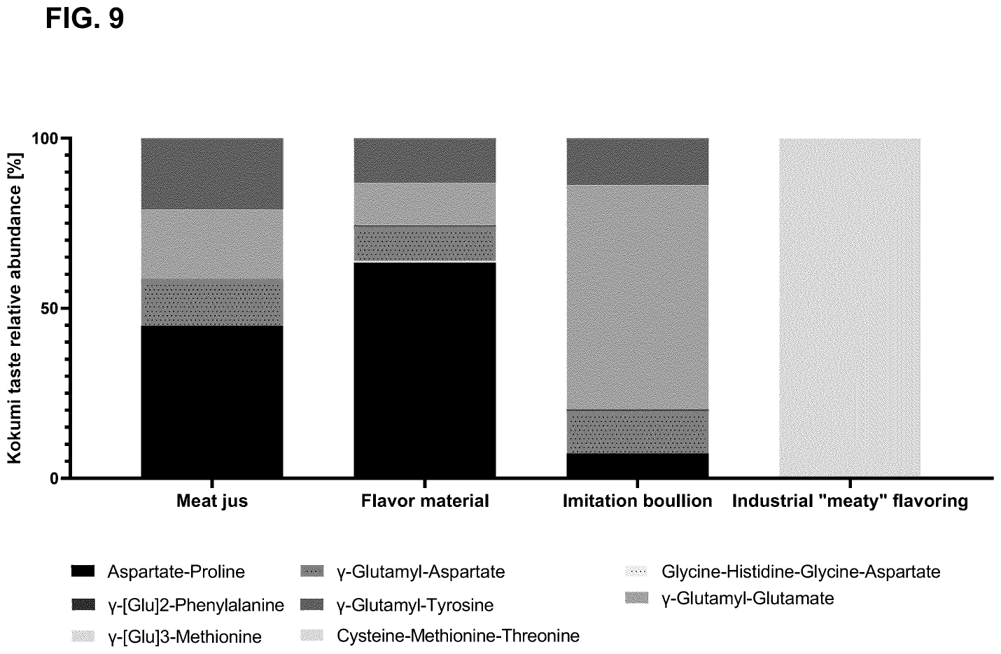

The ‘bitter fingerprint’ (FIG. 8) of the herein disclosed flavor materials shows that the distribution of different bitter substances in the herein disclosed flavor materials resembles that of meat products (here shown meat jus). In particular, the herein disclosed flavor materials contain high levels of arginine, about 40% out of the total bitter substances, in resemblance to meat products (about 35% out of the total bitter substances). Moreover, as in meat, the herein disclosed flavor materials contain distinct levels of lysine and methionine (18% and 3.5% out of the total bitter substances, respectively), as compared to other meat-imitation products.

### Koku Components Distribution

The koku molecules found in significant amounts in the herein disclosed flavor materials are set forth in Table 7 below.

TABLE 7
Kokucompounds

| | FMs 1-4 | | | Industrial |
|---|---|---|---|---|
| | % in product out of | | Imitation meat | meaty |
| Product Name | Koku substances | Meat jus | bouillon | flavoring |
| Glycine-Histidine- | 0.15-0.19 | 0.02-0.05 | 0.6-0.9 | 0 |
| Glycine-Aspartate | | | | |
| γ-Glutamyl-Aspartate | 8-12 | 10-15 | 0 | 0 |
| Cysteine-Methionine- | 0.2-0.8 | 0.05-0.1 | 0 | 100 |
| Threonine | | | | |
| γ-Glutamyl-Tyrosine | 18-22 | 12-15 | 12-15 | 0 |
| Aspartate-Proline | 50-70 | 40-50 | 5-9 | 0 |
| γ-Glutamyl-Glutamate | 10-14 | 18-22 | 55-75 | 0 |
| γ-[Glu]2-Phenylalanine | 0.2-0.4 | 0 | 0.2-0.4 | 0 |
| γ-[Glu]3-Methionine | 0.01-0.03 | 0.04-0.06 | 0 | 0 |

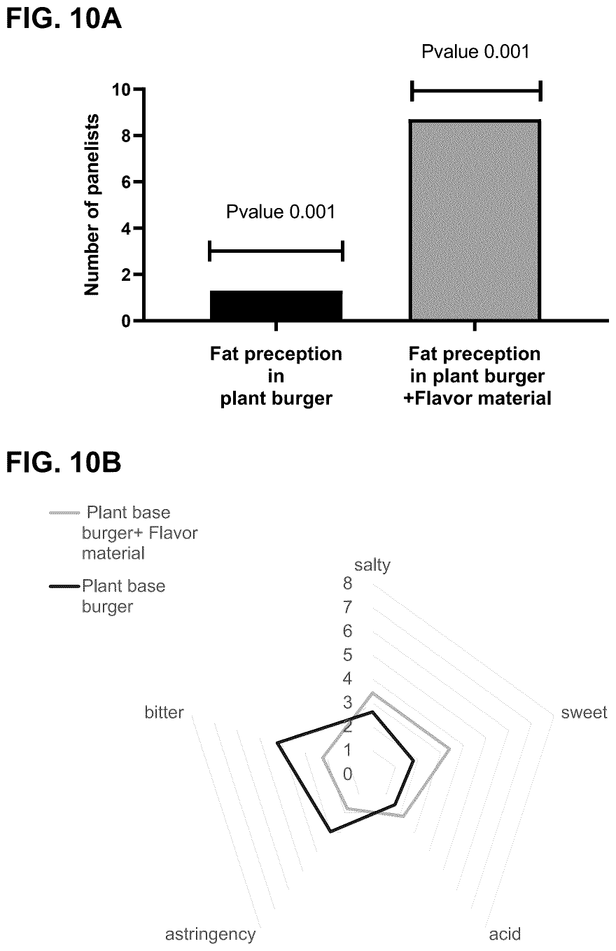

As further seen from FIG. 9, the herein disclosed flavor materials have a koku profile which highly resembles the koku's substance distribution in meat product (meat jus). As opposed to the herein disclosed flavor materials, industrial meaty flavoring koku profile consists only one substance, Cysteine-Methionine-Threonine peptide out of the substances detected, and devoid other substances such as Aspartate-Proline which appear in meat jus. Furthermore, the distribution of koku substances in imitation meat bouillon different from that of meat product, in particular consists high levels of y-Glutamyl-Glutamate (55-75%) which are much lower in meat jus (18-22%).

Overall, sweet taste found in significant percentage (81.2% out of the total sweet, sour, bitter and umami) in the herein disclosed non-volatile taste distribution set forth in Table 8 below.

TABLE 8
Non-volatile average taste distribution of FMs

| | Umami total | | Bitter total | | Sour total | | Sweet total | |
|---|---|---|---|---|---|---|---|---|
| | % * | % w/w ** | % * | % w/w ** | % * | % w/w ** | % * | % w/w ** |
| Average | 8.8 | 0.71 | 5.3 | 0.42 | 4.7 | 0.37 | 81.2 | 6.64 |
| Minimum | 8.0 | 0.62 | 4.8 | 0.32 | 3.6 | 0.31 | 78.9 | 5.0 |
| Maximum | 9.8 | 0.84 | 6.2 | 0.53 | 6.3 | 0.45 | 83.2 | 7.0 |

* out of total taste substances (sweet, sour, bitter and umami).
** gr/100 gr product.

As seen from table 8, the herein disclosed flavor materials have taste distribution consist of an average of 8.8% umami, 5.3% bitter, 4.7% sour and 81.2% sweet out of the total taste substances (i.e., sweet, sour, bitter and umami).

As shown in tables 3-6 and 8, 100 gr of the herein disclosed flavor materials consists about 8.2 gr (about 8.2% w/w) of the taste substances sweet, sour, bitter and umami, with distribution of: about 0.71% w/w of umami substances (from about 0.62 gr to 0.84 gr), about 0.42% w/w of bitter substances (from about 0.32 gr to 0.53 gr), about 0.37% w/w of sour substances (from 0.31 gr to 0.45 gr), and about 6.6% w/w of sweet substances (from about 5.0 gr to 7.0 gr).

### Example 3—Sensory Assessments for Flavor Materials (FM-1, FM-2 and FM-3)

### Fat Perception

For fat perception analysis, a plant-based burger was used as the reference sample. As shown in FIG. 10A, 90% of the panelists assessed “plant burger with FM” with higher fat perception than the reference sample. As shown in FIG. 10B, bitter and astringency are the dominant taste sensations of “plant burger”, quantified at 4 and at 3 respectfully (black polygonal). Conspicuously, the dominant taste sensations of the average results of the FMs (FM-1, FM-2 and FM-3) with “plant burger” are salty and sweet, assessed and quantified both at above level 3 (grey polygonal).

### Bitterness Perception

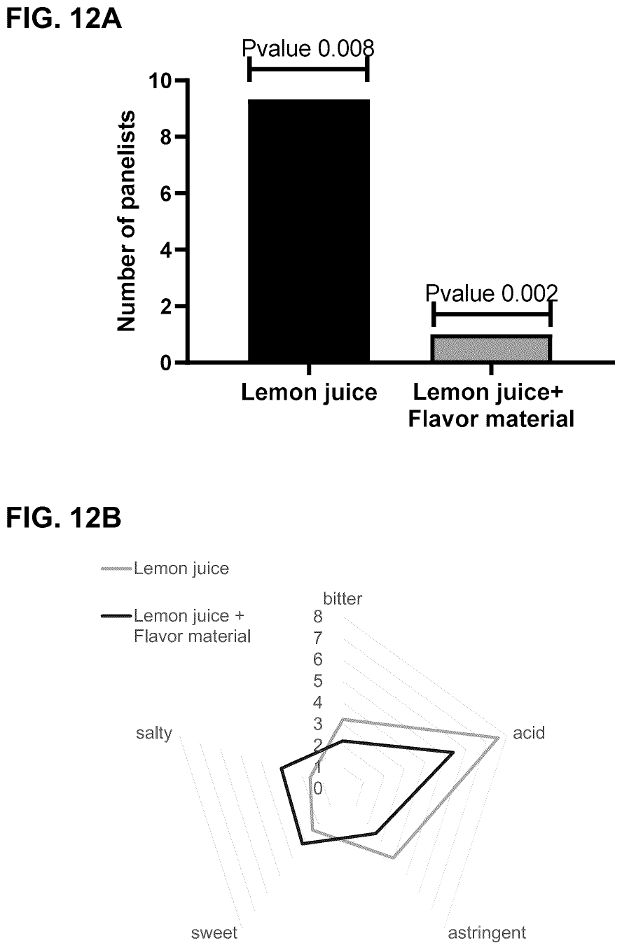

For bitterness perception analysis, a commercial tonic water was used as the reference sample. As shown in FIG. 11A, 90% of the panelists assessed “Tonic” with higher bitter perception than “Tonic with FM”, indicating that the disclosed FMs have the ability to block and/or mask bitterness perception when added to food products. As shown in FIG. 11B, bitter, astringency and sweet are the dominant taste sensations of “tonic” (black polygonal). Bitterness sensation of “Tonic” was quantified above 4.5, whereas in the case of the disclosed FMs “Tonic”, bitterness sensations were assessed in lower intensity levels, in the range of 2-3 (grey polygonal). Thus, further indicating that the disclosed FMs may have the ability to block and/or mask bitterness perception when added to food products.

### Acidity Perception

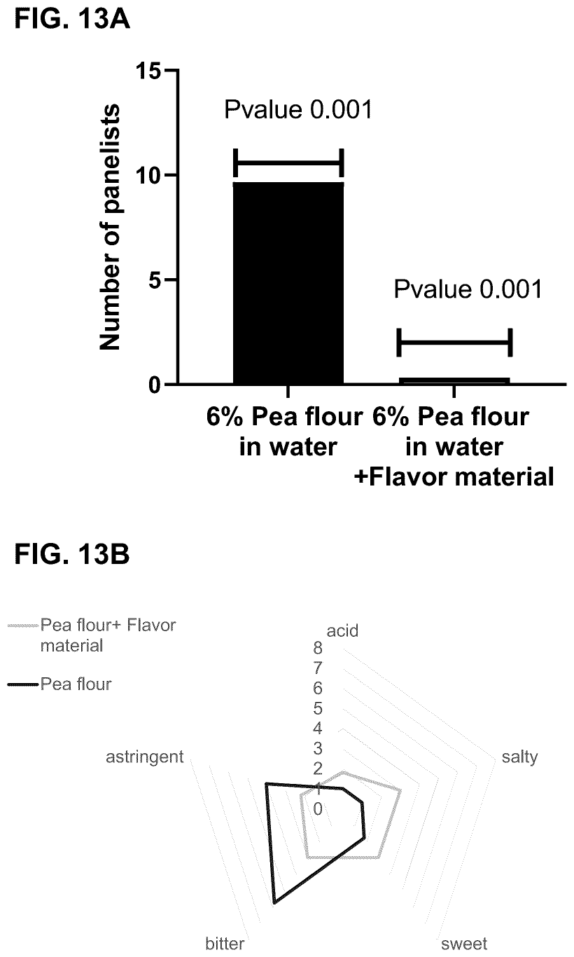

For acidity perception analysis, freshly squeezed lemon juice was used as the reference sample. As shown in FIG. 12A, 90% of the panelists assessed “lemon juice” with higher acidity perception than “lemon juice with FM”, indicating that the disclosed FMs have the ability to block and/or mask acidity perception when added to food products. As shown in FIG. 12B, the acid sensation of the lemon juice reference was quantified between 7 and 8 (grey polygonal), whereas in the case of lemon juice with the disclosed FMs, acid sensations were assessed in lower intensity levels, in the range of 5-6 (black polygonal). Thus, further indicating that the disclosed FMs may have the ability to block and/or mask acidity perception when added to food products.

### Beany Off-Flavor Perception

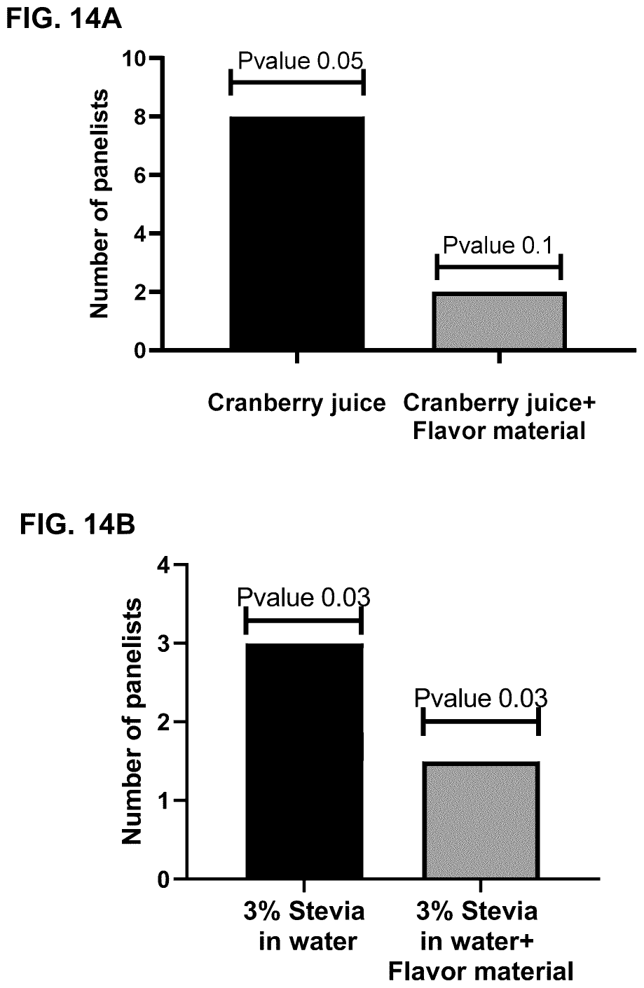

For beany off-flavor perception analysis, pea flour, mixed into water at a dosage of 6% (w/w) was used as the reference sample. As shown in FIG. 13A, 90% of the panelists assessed “6% pea flour in water” with higher beany off-flavor perception than “6% pea flour in water with FM”, indicating that the disclosed FMs may have the ability to block and/or mask beany off-flavor perception when added to food products. As shown in FIG. 13B, bitter and astringent are the dominant sensations of “6% pea flour in water” and were assessed and quantified at 6 and at 4, respectfully (black polygonal). Conspicuously, samples of the disclosed FMs with “6% pea flour in water”, were assessed with lower levels of bitter and astringent sensation intensity; bitterness at 3 and astringent between 2 and 3 (grey polygonal), thus, further indicating that the disclosed FMs may have the ability to block and/or mask beany off-flavor perception when added to food products.

### Astringency Perception

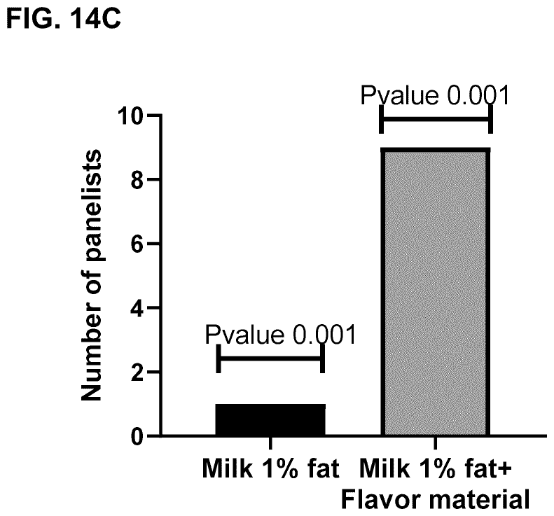

For astringency perception analysis, an unsweetened, commercially available, cranberry juice was used as the reference sample. As shown in FIG. 14A, 80% of the panelists assessed “cranberry juice” with higher astringency perception than “cranberry juice with FM”, indicating that the disclosed FMs may have the ability to reduce astringency perception when added to food products.

### Stevia Off-Flavor Perception

For Stevia off-flavor perception analysis, a solution of commercially available stevia mixed, in water at 3% (w/w) was used as the reference sample. As shown in FIG. 14B, 75% of the panelists assessed “3% stevia in water” with higher Stevia off-flavor perception than “3% stevia in water with FM”, indicating that the disclosed FMs may have the ability to reduce Stevia off-flavor perception when added to food products.

### Mouthfeel Perception

For Mouthfeel perception analysis, commercially available “skim” milk (1% fat) was used as the reference sample. As shown in FIG. 14C, 90% of the panelists assessed “milk 1% fat with FM” with better, more satisfactory mouthfeel perception than “milk 1% fat”, indicating that the herein-disclosed flavor materials may have the ability to improve creaminess and milk fatty mouthfeel perception.

Overall, the herein presented results demonstrate that the herein disclosed flavor materials have a unique volatile and non-volatile profile, which differentiate them from known flavor materials (such as imitation meat bouillon, and industrial meaty flavors) used to replace meat products and/or impart a meaty flavor to meat-substitutes or other foods, in particular due to said unique volatile and non-volatile profile as well as their high amount of sweet and sour substances and their distribution.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

1-34. (canceled)

35. A consumable flavor rich flavor material comprising:
at least one volatile substance at an odor activity value (OAV) of at least 10, the volatile substance comprising 2,3-Octanedione; and
a non-volatile taste distribution of:
about 50-85% non-volatile taste substances having a sweet taste,
about 3-25% non-volatile taste substances having a sour taste;
about 4-25% non-volatile taste substances having a bitter taste; and
about 2-10% of non-volatile taste substances having an umami taste;
out of a total amount of the non-volatile sweet, sour, bitter and umami taste substances;
wherein the flavor material is meatless.

36. The consumable flavor rich flavor material of claim 35, wherein the volatile substance having an odor activity value (OAV) of at least 10 further comprise one or more of: 3-methyl-Butanal, 2-methyl-Butanal, 2,6-dimethyl-Pyrazine, a-ethylidene-Benzeneacetaldehyde, dimethyl Trisulfide, 1H-indole, 2-propenal and Hexadecanoic acid, ethyl ester.

37. The consumable flavor rich flavor material of claim 35, wherein the non-volatile taste substances comprise a taste distribution of:
about 5-7% w/w non-volatile taste substances having a sweet taste,
about 0.31-0.45% w/w non-volatile taste substances having a sour taste;
about 0.32-0.53% w/w non-volatile taste substances having a bitter taste; and
about 0.62-0.84% w/w of non-volatile taste substances having an umami taste;
out of the total flavor rich material.

38. The consumable flavor rich flavor material of claim 35, wherein the OAV of the 2,3-octanedione is at least 40.

39. The consumable flavor rich flavor material of claim 35, wherein the taste substances having a sweet taste comprises alanine, proline, fructose, rhamnose, asparagine, serine, mannitol, sucrose, glutamine, threonine, myo-inositol, glycine, glucose and/or raffinose; and/or wherein the taste substances having a sour taste comprises lactic acid, citric acid, maleic acid, succinic acid and/or tartaric acid.

40. The consumable flavor rich flavor material of claim 35, wherein the taste substances having a bitter taste comprises valine, isoleucine, phenylalanine, lysine, tyrosine, leucine, arginine, cysteine, histidine, methionine and/or tryptophan.

41. The consumable flavor rich flavor material according to claim 35, wherein the umami taste substance comprises glutamate, aspartate and/or betaine.

42. The consumable flavor rich flavor material according to claim 35, having a meaty flavor.

43. The consumable flavor rich flavor material according to claim 35, obtained by solid state fermentation of one or more legumes, grains, vegetables, nuts, oil seeds, agro-industrial waste materials, or any combinations thereof.

44. A consumable composition comprising the flavor rich and/or sensorially active flavor material according to claim 35.

45. The consumable composition according to claim 44, further comprising a flavor base.

46. A method for providing meat flavor to a meatless food product, the method comprising the addition of the consumable flavor rich flavor material according to claim 35, or a composition comprising the same to the meatless food product.

47. A food product comprising the consumable flavor rich flavor material according to claim 35, or a composition comprising the same.

48. The food product of claim 47, being a plant-based food product.

49. The food product of claim 47 being one or more of: a sauce, a condiment, a ready-to-cook or ready-to-eat food product, a stock, a bullion, and/or fish-sauce analogue.

50. The food product of claim 49, being a taste intensifier/enhancer.

51. The consumable flavor rich flavor material according to claim 35, being a taste modulator.

52. The consumable flavor rich flavor material according to claim 35, capable of at least partially blocking and/or masking one of more of: beany off flavor, bitterness, alternative sweeteners off-flavor, astringency and/or sour taste.

53. The consumable flavor rich flavor material according to claim 35, capable of: at least partially enhancing fat perception or mouthfeel, at least partially modulating mouthfeel of reduced sugar food products, at least partially enhancing creamy and/or milk-fatty mouthfeel, and/or least partially increasing taste complexity in reduced salt food products.
